(19) United States
(12) Patent Application Publication
(10) Pub. No.: US 2020/0076911 A1
(43) Pub. Date: Mar. 5, 2020

(54) INFORMATION UPDATING METHOD, INFORMATION UPDATING SYSTEM, AND COMPUTER-READABLE RECORDING MEDIUM

(71) Applicant: Panasonic Intellectual Property Management Co., Ltd., Osaka (JP)

(72) Inventor: Takayuki NISHIKAWA, Osaka (JP)

(21) Appl. No.: 16/546,592

(22) Filed: Aug. 21, 2019

(30) Foreign Application Priority Data
Aug. 28, 2018 (JP) 2018-159579

(51) Int. Cl. H04L 29/08; H04L 12/28; G06F 16/23; G06F 16/28

(52) U.S. Cl. CPC H04L 67/22; H04L 12/2825; H04L 2012/285; G06F 16/285; G06F 16/2379

(57) ABSTRACT

It is estimated whether or not a change is caused in a user's mode of living related to personal information, based on operation log information including an operating date-and-time of a domestic electrical appliance possessed by a user. When it is estimated that the user's mode of living is changed, an update request which requests an update of the personal information is sent to an information processing terminal of the user within a predetermined time frame from an instant of estimation.

### FIELD OF THE INVENTION

The present disclosure relates to a technique for updating user's personal information registered with a service provider which provides services utilizing a domestic electrical appliance.

### BACKGROUND ART

In recent years, for the purpose of providing various services regarding a domestic electrical appliance to a user, the user is required to register user's personal information with a service provider. However, the personal information is changed due to a move or the like of the user.

Hence, J P 2008-217175 A discloses a technique in which an address management server monitors user's positional information which corresponds to a user's address which is regularly sent from a user's communications terminal and a process for changing the user's address is automatically performed when the user's positional information is changed.

However, according to the technique of JP 2008-217175 A, a user's address is the only information that can be automatically updated, and a kind of information, such as a family structure or an occupation, a change of which is difficult for a service provider to keep track of, cannot be updated. Thus, there is a need for further improvement.

### SUMMARY OF INVENTION

The present disclosure is to solve the above-described problem, and it is an object of the present disclosure to provide a technique which suppresses a situation in which user's personal information registered with a service provider fails to be updated to the latest information.

An information updating method according to one aspect of the present disclosure is an information updating method for updating user's personal information registered with a service provider that provides a service utilizing a domestic electrical appliance, the information updating method including: estimating, by a computer, whether or not a change is caused in a user's mode of living related to the personal information, based on operation log information including an operating date-and-time of the domestic electrical appliance possessed by a user; and sending, by the computer, an update request that requests an update of the personal information to an information processing terminal of the user within a predetermined time frame from an instant of estimation when it is estimated that the user's mode of living is changed.

With this configuration, it is possible to suppress a situation in which user's personal information registered with a service provider fails to be updated to the latest information.

### BRIEF DESCRIPTION OF DRAWINGS

FIG. 1 is a view showing an example of a configuration of an information updating system according to a first embodiment of the present disclosure;

FIG. 2A is a view showing an example of operation log information;

FIG. 2B is a view showing an example of operation log information which is managed by a log-information management unit;

FIG. 3 is a view showing an example of a registration screen which is displayed on a display unit of an information processing terminal when a user inputs user's personal information;

FIG. 4A is a view showing an example of personal information generated by a personal-information generation unit;

FIG. 4B is a view showing an example of personal information which is managed by a personal-information management unit;

FIG. 5 is a view showing an example of an input screen which is displayed on the display unit when a user inputs appliance information about a domestic electrical appliance that the user possesses;

FIG. 6A is a view showing an example of appliance information generated by an appliance-information generation unit;

FIG. 6B is a view showing an example of appliance information which is managed by an appliance-information management unit;

FIG. 7A is a view showing an example of operation distribution information in a case where a unit time period is set to one hour;

FIG. 7B is a view showing an example of operation distribution information stored in an operation-distribution-information storage unit in a case where a unit time period is set to one hour;

FIG. 8A is a view showing an example of group information which is managed by a group management unit;

FIG. 8B is a view showing an example in which group information including a new group ID is added to the group information which is managed by the group management unit;

FIG. 9 is a flow chart showing an example of an estimation process performed by a change estimation unit shown in FIG. 1;

FIG. 10A is a view showing an example of operation distribution information which is provided immediately after operation distribution information including a week ID “2018-04-09” is stored in the operation-distribution-information storage unit;

FIG. 10B is a view showing operation distribution information which is provided immediately after a group to which the operation distribution information shown in FIG. 10A belongs is determined;

FIG. 11 is a view showing an example in which a new group ID is given to operation distribution information forming a first operation distribution party;

FIG. 12 is a view showing an example of a notification screen which is displayed on the display unit of the information processing terminal which is notified of an update request;

FIG. 13 is a view showing an example of a notification screen which is displayed in a different manner on the display unit of the information processing terminal which is notified of an update request;

FIG. 14 is a view showing an example of another notification screen which is displayed on the display unit of the information processing terminal which is notified of an update request;

FIG. 15 is a flow chart showing an example of a process in which a server of the information updating system estimates whether or not a change is caused in a user's mode of living, from operation log information about a domestic electrical appliance, and provides notification of an update request;

FIG. 16 is a view showing an example of a configuration of an information updating system according to a second embodiment;

FIG. 17A is a view showing an example of notifying-date-and-time information generated by a notifying-date-and-time-information generation unit.

FIG. 17B is a view showing an example of notifying-date-and-time information managed by a notifying-date-and-time-information management unit;

FIG. 18 is a flow chart showing an example of a process in which a server of the information updating system according to the second embodiment estimates whether or not a change is caused in a user's mode of living, from operation log information about a domestic electrical appliance, and estimates an at-home time period of a user;

FIG. 19 is a flow chart showing an example of a process of notifying a user of an update request; and

FIG. 20 is a view for briefly describing the estimation process performed by the change estimation unit.

### DESCRIPTION OF EMBODIMENTS

(Circumstances Leading to the Present Disclosure)

In recent years, a domestic electrical appliance which is connected to a network and is interoperable with a server or a cloud in the outside is increasing in number. To connect a domestic electrical appliance to a network allows a user to use services for remote control of a domestic electrical appliance from outside, reception of a recommendation regarding a method of using a domestic electrical appliance in accordance with a user's mode of living, and the like. Meanwhile, a service provider which provides the above-described services more accurately grasps an actual state of use, a use tendency, and the like of domestic electrical appliances which are offered by its own company by collecting use log information about domestic electrical appliances of users, so that domestic electrical appliances and services which are offered by its own company can be improved.

Here, it is noted that use log information about a domestic electrical appliance includes: operation log information which indicates a detail of an operation performed on a domestic electrical appliance by a user, such as a start of washing of a washing machine, a start of operation of an air conditioner, or opening/closing of a refrigerator; and state log information which is regularly observed by a sensor contained in a domestic electrical appliance and indicates a state of an appliance and a state of surroundings.

When a user uses a service which connects a domestic electrical appliance to a network, it is general that a user permits a service provider to collect use log information about his domestic electrical appliances, and registers his personal information with the service provider at a start of a service. Here, it is noted that user's personal information means information about an age, a sex, a place of residence, a state of residence, a family structure, an occupation, preference, and the like of a user. A service provider analyzes such personal information and use log information while associating them with each other, so that a service conforming to an individual user can be provided and a use tendency of a domestic electrical appliance according to a sex, an age, an area, or the like can be kept track of.

After a user registers his personal information at a start of use of a service, it is general that an operation of updating user's personal information which is registered with a service provider, except a kind of information such as an age, a change of which is easy for a service provider to keep track of, is left to a user. Accordingly, even if a significant change is caused in a living environment of a user, personal information as is provided before a change in a living environment, and use log information are associated with each other on a service provider's side also after a change unless a user voluntarily updates his personal information for a service provider. As a result of this, there arises a problem of a mismatch between a detail of a service being provided to a user, together with a result of analysis of a use tendency of a domestic electrical appliance, and a user's actual state of use, on a service provider's side. It is noted that as a possible change in a living environment of a user, a change in a family structure because of marriage, birth, bereavement, or the like, a change in a place or state of residence due to a move, and a change of occupation, are cited.

As a solution to the above-described problem, cited is a method in which a service provider grasps a change in a living environment of a user and automatically updates personal information. For example, JP 2008-217175 A discloses an address management system which regularly obtains user's positional information from a communications terminal holding user's positional information and grasps a change in positional information, to automatically update address information.

However, in the configuration of JP 2008-217175 A, a service provider can update only information about a place of residence, and JP 2008-217175 A provides no disclosure concerning an update of a kind of personal information such as a family structure or an occupation, a change of which is difficult for a service provider to keep track of. Thus, according to JP 2008-217175 A, it remains dependent on a user's voluntariness whether or not personal information, a change of which is difficult for a service provider to keep track of, is updated, and JP 2008-217175 A cannot solve the above-described problem.

Also, as another solution to the above-described problem, a method in which a service provider regularly sends notification which prompts a user to update personal information by himself, to a user, is conceivable. Nonetheless, according to this method, in a case where notification is sent so frequently, a user may think such notification annoying and disregard the notification, or avoid use of a service itself. Conversely, in a case where notification is sent infrequently, a service provider may use incorrect personal information for a long time, or a user may postpone an operation of updating his personal information and forget to update.

The present disclosure solves the above-described problem, and it is an object to provide techniques which suppress likeliness of a situation in which user's personal information which is about a domestic electrical appliance and is registered with a service provider fails to be updated to the latest information.

An information updating method according to one aspect of the present disclosure is an information updating method for updating user's personal information registered with a service provider that provides a service utilizing a domestic electrical appliance, in which a computer estimates whether or not a change is caused in the user's mode of living related to the personal information, based on operation log information including an operating date-and-time of the domestic electrical appliance possessed by the user, and sends an update request that requests an update of the personal information to an information processing terminal of the user within a predetermined time frame from an instant of estimation when it is estimated that the mode of living of the user is changed.

Generally, when a significant change is caused in a living environment of a user, a user is expected to conduct officially-necessary updating procedures, such as submission of a notification of change of address or a birth report. With the present configuration, a change in a user's mode of living related to personal information is estimated based on operation log information, so that a time when a user's mode of living is significantly changed can be estimated. Then, in the present configuration, an update request of personal information is sent to an information processing terminal of a user within a predetermined time frame from an instant of estimation. Accordingly, the configuration can prompt a user to update personal information registered with a service provider, concurrently with a duration in which a user conducts officially-necessary updating procedures. Hence, the present configuration can increase a possibility that a user himself will be caused to update all pieces of personal information registered with a service provider, including information, a change of which is difficult for a service provider to keep track of. As a consequence, the present configuration can suppress likeliness of a situation in which user's personal information registered with a service provider fails to be updated to the latest information.

In the above-described configuration, in estimating whether or not the mode of living is changed, operation distribution information that indicates an operation occurrence rate of the domestic electrical appliance in each of a plurality of unit time periods forming a first duration may be generated for each of second durations each of which is longer than the first duration, based on the operating date-and-time included in the operation log information, and it is estimated whether or not the mode of living is changed based on the operation distribution information.

If a user's mode of living is changed, respective operation occurrence rates of a domestic electrical appliance in each unit time period in pieces of the operation distribution information for the respective first durations forming the second duration become more likely to have different tendencies. With the present configuration, since whether or not a change is caused in a mode of living is estimated based on the operation distribution information, a change in a mode of living can be accurately estimated.

In the above-described configuration, in sending the update request to the information processing terminal, an at-home time period of the user may be estimated based on the operation distribution information, and the update request may be sent to the information processing terminal within a predetermined time frame around the at-home time period that is estimated.

Since the above-described configuration is designed to estimate an at-home time period of a user based on operation log information, a user is very likely to do some work in the estimated at-home time period. Accordingly, if a configuration in which notification of an update request is provided within an at-home time period is employed, there is a possibility that a user cannot cope with such notification. With the present configuration, an update request is sent within a predetermined time frame around an at-home time period, so that an update request can be sent in a time period in which a user is estimated to be free and a possibility that a user will cope with an update request can be increased.

In the above-described configuration, in estimating the at-home time period, one of the plurality of unit time periods in which the operation occurrence rate of the domestic electrical appliance is the highest may be estimated to be the at-home time period of the user, based on the operation distribution information.

With the present configuration, the unit time period in which an operation occurrence rate of a domestic electrical appliance is the highest is estimated to be an at-home time period of a user, so that an at-home time period of a user can be accurately estimated.

In the above-described configuration, in estimating whether or not the mode of living is changed, when the number of times of occurrence of operation on the domestic electrical appliance for a certain one of the second durations is smaller than a predetermined number of times, generation of the operation distribution information for the certain one of the second durations may be omitted.

In a case where a user is not at home on a trip or for the other like reasons, the number of times of operation performed on a domestic electrical appliance by a user is reduced, and thus, the operation distribution information generated in the second duration in which a user is not at home does not indicate a user's ordinary mode of living. Hence, in the present configuration, in a case where the number of times of occurrence of operation on a domestic electrical appliance in a certain one of the second durations is smaller than the predetermined number of times, the operation distribution information is not generated in the certain one of the second durations, so that it is possible to prevent generation of operation distribution information which does not correctly reflect a user's mode of living.

In the above-described configuration, in estimating whether or not the mode of living is changed: the operation distribution information that is generated for each of the second durations may be divided into a first operation distribution party including pieces of the operation distribution information for most recent plural ones of the second durations, and a second operation distribution party including pieces of the operation distribution information for another plural ones of the second durations before the most recent plural second durations; one or more groups may be generated by classification of the pieces of the operation distribution information forming the second operation distribution party, according to a tendency of the operation occurrence rate in each of the unit time periods; and when each of the pieces of the operation distribution information for each of the second durations, the pieces being included in the first operation distribution party, does not belong to a latest group that is one of the groups that includes a piece of the operation distribution information for a latest one of the second durations and the respective operation occurrence rates in each of the unit time periods in the pieces being included in the first operation distribution party have the same tendency, it may be estimated that the mode of living is changed.

With the present configuration, when respective operation occurrence rates in each unit time period in a plurality of pieces of operation distribution information being provided most recently have the same tendency, and have a tendency different from that of operation distribution information forming the latest group, it is judged that a user's mode of living is changed. Accordingly, it is possible to prevent a situation in which it is judged that a mode of living is changed when a user temporarily performs an operation on a domestic electrical appliance in a manner different from that in ordinary times.

In the above-described configuration, in estimating whether or not the mode of living is changed: a reference range for each of the unit time periods may be calculated for each of the groups, from an average and a standard deviation of the operation occurrence rate in each of the unit time periods; and when in first operation distribution information that is a piece of the operation distribution information for a certain one of the second durations, the piece included in the first operation distribution party, the operation occurrence rate in at least one of the unit time periods is out of the reference range for the same unit time period of the latest group, it may be judged that the first operation distribution information does not belong to the latest group.

With the present configuration, in the first operation distribution information belonging to the first operation distribution party, when an operation occurrence rate in at least one unit time period does not fall within a reference range for the same unit time period of the latest group, it is judged that the first operation distribution information does not belong to the latest group. Accordingly, it is possible to correctly judge whether or not the first operation distribution information belongs to the latest group.

In the above-described configuration, in estimating whether or not the mode of living is changed, in all pieces of the operation distribution information included in the first operation distribution party, when all of the respective unit time periods in each of which the operation occurrence rate is out of the reference range with respect to the latest group are identical to each other, it may be judged that the respective operation occurrence rates in each of the unit time periods have the same tendency.

With the above-described configuration, when in pieces of operation distribution information included in the first operation distribution party, all of respective unit time periods in each of which an operation occurrence rate is out of a reference range with respect to the latest group are identical, it is judged that the respective operation occurrence rates have the same tendency. Accordingly, it is possible to correctly judge whether or not respective pieces of operation distribution information included in the first operation distribution party have the same tendency.

In the above-described configuration, the update request may contain detailed matters of the personal information that is currently registered with the service provider.

With the present configuration, detailed matters of personal information which is currently registered with a service provider can be shown to a user in sending an update request, so that a user can quickly recognize a difference between personal information as is registered with a service provider and the latest personal information. Accordingly, it is possible to cause a user to appreciate a need for an operation of updating personal information.

In the above-described configuration, the update request may contain information about the last update date-and-time of the personal information that is currently registered with the service provider.

With the present configuration, the last update date-and-time of personal information which is currently registered with a service provider can be shown to a user in sending an update request, so that a user quickly recognize whether or not personal information which is being registered with a service provider is the latest personal information.

In the above-described configuration, the change in the mode of living may include at least one of a change in a family structure and a change in an occupation.

With the above-described configuration, it is possible to request a user to update personal information after it is estimated that at least one of a family structure and an occupation is changed.

In the above-described configuration, the first duration may be one day.

With the present configuration, since the first duration is one day, a plurality of days can be defined as each of the second durations.

In the above-described configuration, the second duration may be one week.

With the present configuration, since the second duration is one week, the operation distribution information can be generated on a weekly basis.

Additionally, the above-described effects produced by the information updating method can be produced also by an information updating system and an information updating program in the same manner.

The present disclosure can be implemented as an information updating program which causes a computer to achieve each of characteristic configurations included in the above-described information updating method, or as an information updating apparatus which is operated by the foregoing information updating program. Also, it goes without saying that such computer program can be distributed either in the form of a non-temporary computer-readable recording medium such as CD-ROM, or via a communications network such as the Internet.

It should be noted that each of the following embodiments describes one specific example of the present disclosure. Numerical values, shapes, components, steps, sequences of steps, and the like, which will be described in the following embodiments, are mere examples, and do not limit the present disclosure in essence. Also, out of components in the following embodiments, components not recited in independent claims which indicate the broadest concept will be described as arbitrary components. Further, in all of the embodiments, respective contents can be combined with each other.

Hereinbelow, embodiments of the present disclosure will be described with reference to the drawings.

### First Embodiment

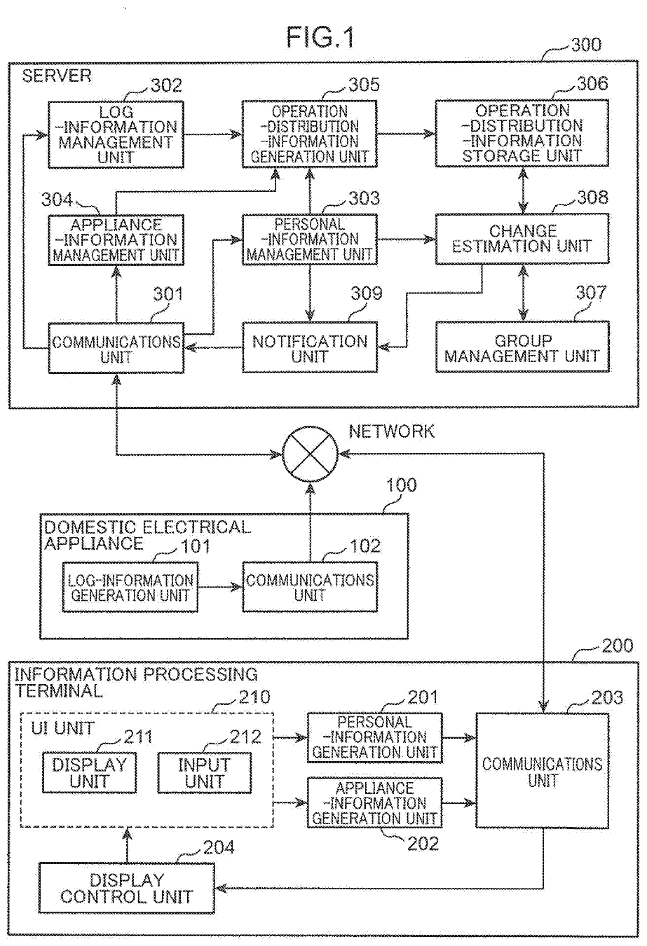

FIG. 1 is a view showing an example of a configuration of an information updating system according to a first embodiment of the present disclosure. The information updating system according to the present embodiment includes a domestic electrical appliance 100 possessed by a user, an information processing terminal 200 possessed by a user, and a server 300 with which a service provider provides services, and each of the domestic electrical appliance 100 and the information processing terminal 200 is connected to the server 300 via a network. The network is formed of a wide area network (WAN) including the Internet, a mobile-phone communications network, and the like, for example.

As the domestic electrical appliance 100, an electrical appliance for domestic use placed in a user's home, such as a refrigerator, a washing machine, an air conditioner, a microwave oven, an oven, audio equipment, a television, a personal computer, or the like, is employed, for example. A user's home may be either a detached house or a multifamily dwelling such as a condominium.

The information processing terminal 200 may be formed of either a mobile terminal that a user carries, such as a smartphone or a tablet, or a desktop computer placed in a user's home.

The server 300 is formed of a cloud server including one or more computers, and includes a personal-information database in which personal information about one or more users who are targets of provision of a service regarding the domestic electrical appliance 100 is stored.

A service provider is a corporate body or the like which provides a user who possesses the domestic electrical appliance 100, with a service regarding the domestic electrical appliance 100, and may be a manufacturer of the domestic electrical appliance 100, a service provider to which some work is outsourced by the manufacturer, or a service provider which specializes in provision of a service regarding the domestic electrical appliance 100, for example.

A service provided by a service provider includes a service for allowing a user to remotely control the domestic electrical appliance 100 from outside, a service for notifying a user of a recommendation regarding a method of using a domestic electrical appliance 100 in accordance with a user's mode of living, a service for giving an advice as to remedies at a time of breakdown of the domestic electrical appliance 100, a service for arranging a serviceman, and the like, for example.

Below, a detailed configuration of each of the domestic electrical appliance 100, the information processing terminal 200, and the server 300 will be described.

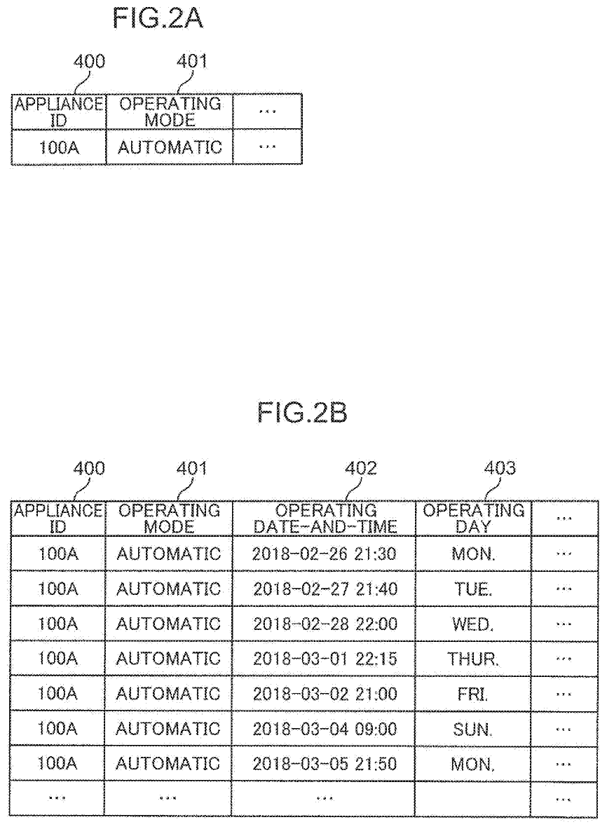

The domestic electrical appliance 100 mainly includes a log-information generation unit 101 and a communications unit 102. Additionally, the log-information generation unit 101 is formed of an electric circuit (a microcontroller, for example) which has control over the domestic electrical appliance 100. The log-information generation unit 101 generates operation log information in which a detail of an operation at a time when a user operates the domestic electrical appliance 100 is recorded. FIG. 2A is a view showing an example of operation log information. As shown in FIG. 2A, operation log information includes items of an appliance ID 400 and an operating mode 401. The appliance ID 400 is an identifier (ID) for uniquely identifying the domestic electrical appliance 100. The operating mode 401 is a type of an operating mode of the domestic electrical appliance 100 which starts to operate upon a user's operation.

The log-information generation unit 101 generates operation log information, and sends operation log information to the server 300 via the communications unit 102. It is noted that items included in operation log information are not limited to the appliance ID 400 and the operating mode 401, and a detail of an arbitrary operation for a function of the domestic electrical appliance 100 may be employed as an item.

The communications unit 102 has a function of sending/receiving data to/from an external apparatus through a communications circuit such as communication using a wire LAN, a wireless LAN, Bluetooth (registered trademark), a communications network of a carrier of a mobile information terminal. For example, the communications unit 102 is connected to a router placed at home by radio or wire, and establishes connection for communication with the server 300 and the domestic electrical appliance 100 via the router.

The information processing terminal 200 mainly includes a user interface (UI) unit 210, a personal-information generation unit 201, an appliance-information generation unit 202, a communications unit 203, and a display control unit 204. Among those components, a hardware configuration of the communications unit 203 is similar to that of the communications unit 102 of the domestic electrical appliance 100. The personal-information generation unit 201, the appliance-information generation unit 202, and the display control unit 204 may be implemented in such a manner that a processor such as a CPU executes a program stored in a not-shown memory, or may be formed of a dedicated hardware circuit, for example.

The UI unit 210 mainly includes a display unit 211 including a displaying apparatus such as an organic EL or an LCD, and an input unit 212 including an inputting apparatus such as a hard key and a soft key. Additionally, the input unit 212 may include a touch panel which is formed integrally with the display unit 211.

The personal-information generation unit 201 generates personal information including information which is about a user himself and is registered with a service provider, based on information which is input by a user with the input unit 212 pursuant to what is displayed on the display unit 211.

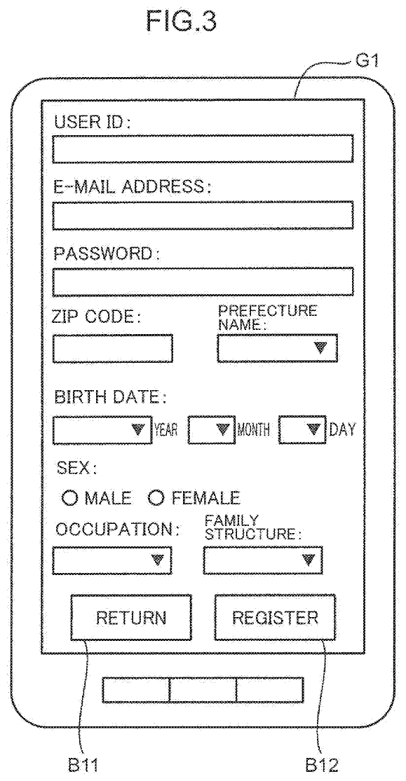

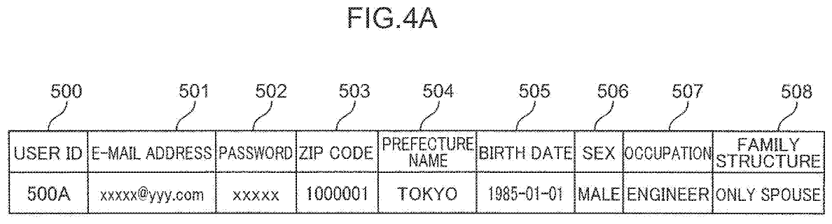

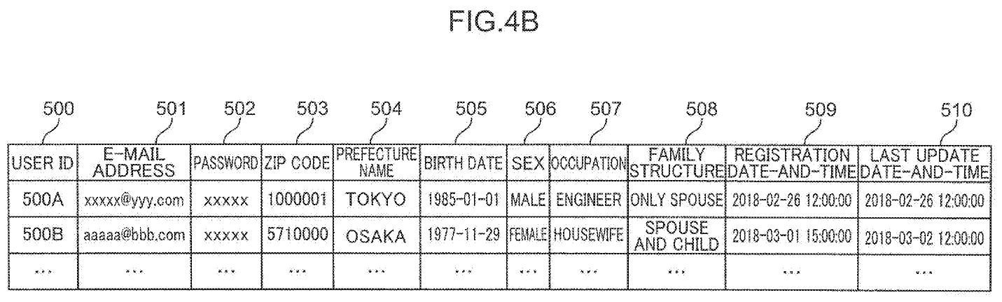

FIG. 3 is a view showing an example of a registration screen G1 which is displayed on the display unit 211 of the information processing terminal 200 when a user inputs his personal information. The registration screen G1 includes input fields for a “user ID”, an “e-mail address”, a “password”, a “zip code”, a “prefecture name”, a “birth date”, a “sex”, an “occupation”, and a “family structure”, a return button B11, and a registration button B12. A user inputs necessary information into those input fields with the use of the input unit 212, and inputs an operation of selecting the registration button B12 bearing “REGISTER”, using the input unit 212. Then, personal information is generated by the personal-information generation unit 201. Additionally, respective pieces of information input into the input fields in the registration screen G1 are set as values of items under the same names in FIG. 4A. The return button B11 is a button for returning a screen displayed on the display unit 211 back to a screen which is displayed before the registration screen G1.

FIG. 4A is a view showing an example of personal information generated by the personal-information generation unit 201. As shown in FIG. 4A, personal information includes items of a user ID 500, an e-mail address 501, a password 502, a zip code 503, a prefecture name 504, a birth date 505, a sex 506, an occupation 507, and a family structure 508.

The user ID 500 is an ID for uniquely identifying a user. The e-mail address 501 is an e-mail address serving as contact information of a user. The information processing terminal 200 can send/receive information using the e-mail address. The password 502 is a password used by a user for authentication when using a service. The zip code 503 is a zip code corresponding to a user's place of residence. The prefecture name 504 is a name of a prefecture in which a user's place of residence is present. The birth date 505 is a date of birth of a user. The sex 506 is a user's sex. The occupation 507 is a user's occupation. The family structure 508 is a user's family structure regarding presence or absence of a spouse and a child who live together. It is noted that items of personal information are not limited to those including the user ID 500 to the family structure 508, and an arbitrary item required by a service provider may be included.

Reference is made back to FIG. 1. When the personal-information generation unit 201 finishes generating personal information, the personal-information generation unit 201 sends personal information to the server 300 via the communications unit 203.

The appliance-information generation unit 202 generates appliance information including information which is about the domestic electrical appliance 100 and is required for registering the domestic electrical appliance possessed by a user with a service provider, based on information which is input by a user with the input unit 212 pursuant to what is displayed on the display unit 211.

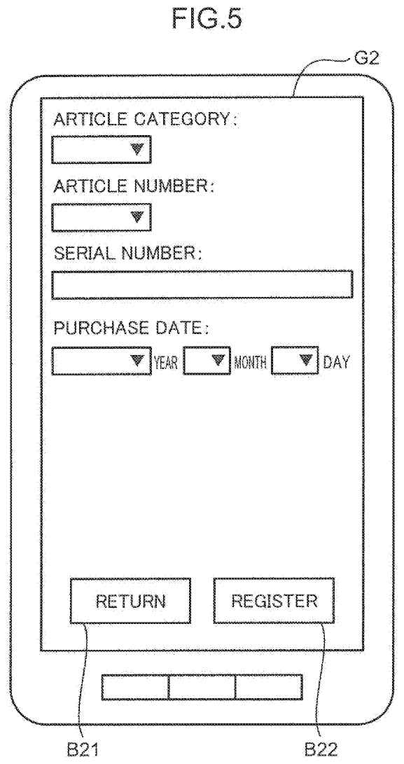

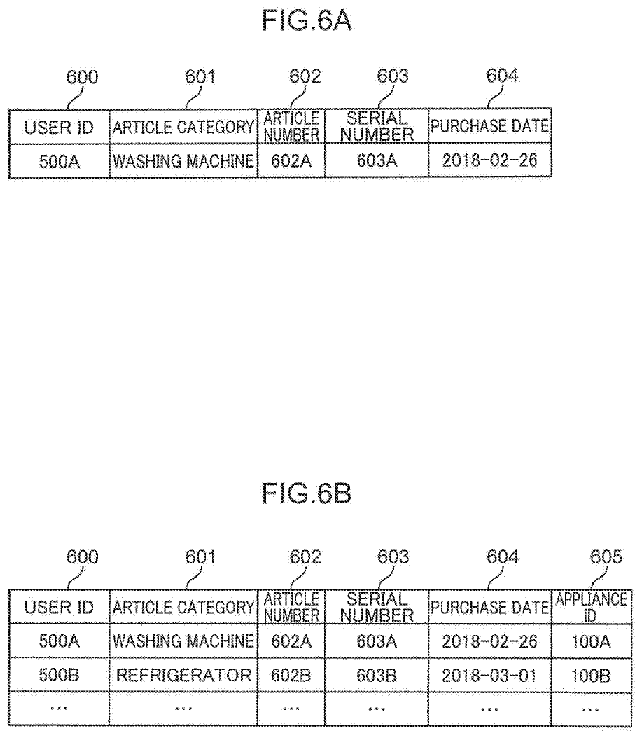

FIG. 5 is a view showing an example of an input screen G2 which is displayed on the display unit 211 when a user inputs appliance information about the domestic electrical appliance 100 possessed by a user. The input screen G2 includes input fields for an “article category”, an “article number”, a “serial number”, and a “purchase date”, a return button B21, and a registration button B22. A user inputs necessary information into those input fields with the use of the input unit 212, and inputs an operation of selecting the registration button B22 bearing “REGISTER”, using the input unit 212. Then, appliance information is generated by the appliance-information generation unit 202. Additionally, respective pieces of information input into the input fields in the input screen G2 are set as values of items under the same names in FIG. 6A. The return button B21 is similar to the return button B11 in the registration screen G1.

FIG. 6A is a view showing an example of appliance information generated by the appliance-information generation unit 202. As shown in FIG. 6A, appliance information includes items of a user ID 600, an article category 601, an article number 602, a serial number 603, and a purchase date 604.

The user ID 600 is an ID for uniquely identifying a user, and has the same value as the user ID 500 of personal information. The article category 601 is a kind of the domestic electrical appliance 100 registered by a user, such as an air conditioner, a refrigerator, or a washing machine. The article number 602 is an article number which is assigned to the domestic electrical appliance 100 and is registered by a user. The serial number 603 is a number which uniquely identifies the domestic electrical appliance 100, and is formed of information which can be easily confirmed by a user based on information inscribed on a body of the domestic electrical appliance 100, or the like. The purchase date 604 is a date when a user purchases the domestic electrical appliance 100. It is noted that items of appliance information are not limited to those including the user ID 600 to the purchase date 604, and an arbitrary item required by a service provider may be included. When the appliance-information generation unit 202 finishes generating appliance information, the appliance-information generation unit 202 sends appliance information to the server 300 via the communications unit 203.

The display control unit 204, in response to an update request received from a notification unit 309 (which will be later described) of the server 300 via the communications unit 203, generates a screen which prompts a user to update personal information, and displays it on the display unit 211.

Reference is made back to FIG. 1. The server 300 mainly includes a communications unit 301, a log-information management unit 302, a personal-information management unit 303, an appliance-information management unit 304, an operation-distribution-information generation unit 305, an operation-distribution-information storage unit 306, a group management unit 307, a change estimation unit 308, and a notification unit 309. Among those components, a hardware configuration of the communications unit 301 is similar to that of the communications unit 102 of the domestic electrical appliance 100 and that of the communications unit 203 of the information processing terminal 200. Also, the log-information management unit 302, the personal-information management unit 303, the appliance-information management unit 304, and the group management unit 307 are formed of a processor such as a CPU and a memory such as a semiconductor memory, for example. Also, the operation-distribution-information generation unit 305, the change estimation unit 308, and the notification unit 309 are formed of a processor, for example. Also, the operation-distribution-information storage unit 306 is formed of a memory, for example. It is noted that each block forming the server 300 may be implemented in such a manner that a processor executes an information updating program which causes a computer to function as an information updating system, or may be formed of a dedicated hardware circuit. The foregoing information updating program may be recorded on a non-temporary computer-readable recording medium such as a CD-ROM or DVD-ROM, to be put on the market.

The log-information management unit 302 cumulatively stores operation log information sent from the domestic electrical appliance 100 into a memory, and manages operation log information. FIG. 2B is a view showing an example of operation log information which is managed by the log-information management unit 302. As shown in FIG. 2B, operation log information managed by the log-information management unit 302 is managed in a table form in which one record corresponds to one piece of operation log information, and further includes items of an operating date-and-time 402 and an operating day 403, in addition to the items of the appliance ID 400 and the operating mode 401 which are included in operation log information shown in FIG. 2A. The operating date-and-time 402 and the operating day 403 are respectively a date-and-time and a day when the log-information management unit 302 receives operation log information from the domestic electrical appliance 100 and are given by the log-information management unit 302.

The personal-information management unit 303 stores personal information sent from the information processing terminal 200 into a memory, and manages personal information. FIG. 4B is a view showing an example of personal information which is managed by the personal-information management unit 303. As shown in FIG. 4B, personal information managed by the personal-information management unit 303 is managed in a table form in which one record corresponds to one piece of personal information, and further includes items of a registration date-and-time 509 and a last update date-and-time 510, in addition to the items of the user ID 500, the e-mail address 501, the password 502, the zip code 503, the prefecture name 504, the birth date 505, the sex 506, the occupation 507, and the family structure 508 which are included in personal information shown in FIG. 4A.

The registration date-and-time 509 is a date-and-time when personal information of each user starts to be managed by the personal-information management unit 303. The last update date-and-time 510 is the last date-and-time when personal information managed by the personal-information management unit 303 is updated by a user himself.

The appliance-information management unit 304 stores appliance information sent from the information processing terminal 200 into a memory, and manages appliance information. FIG. 6B is a view showing an example of appliance information which is managed by the appliance-information management unit 304. As shown in FIG. 6B, appliance information managed by the appliance-information management unit 304 is managed in a table form in which one record corresponds to one piece of appliance information, and includes items of the user ID 600, the article category 601, the article number 602, the serial number 603, and the purchase date 604, and an appliance ID 605. The foregoing items from the user ID 600 to the purchase date 604 are similar to the items of appliance information shown in FIG. 6A, respectively. The appliance ID 605 is an ID which is generated by conversion of the article number 602 and the serial number 603 in accordance with a predetermined conversion rule when the appliance-information management unit 304 receives appliance information, and is an ID for uniquely identifying the domestic electrical appliance 100. It is noted that for the predetermined conversion rule, any rule that can generate an ID which uniquely identifies the domestic electrical appliance 100 from the article number 602 and the serial number 603 may be employed. Also, the appliance ID 605 may have either the same value as that of the appliance ID 400 included in operation log information which is managed by the log-information management unit 302, or a value which allows one-to-one correspondence.

The operation-distribution-information generation unit 305 generates operation distribution information, based on the appliance ID 400, the operating date-and-time 402, and the operating day 403 which are included in operation log information managed by the log-information management unit 302, the user ID 500 which is included in personal information managed by the personal-information management unit 303, and the user ID 600 and the appliance ID 605 which are included in appliance information managed by the appliance-information management unit 304. Operation distribution information is information which is generated for each user on a weekly basis, and is information which indicates an operation occurrence rate of the domestic electrical appliance 100 in each unit time period.

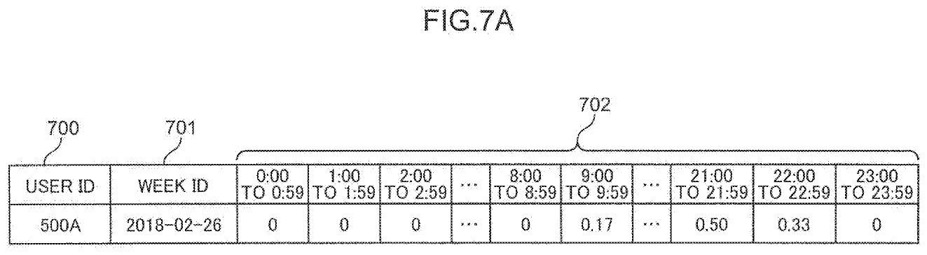

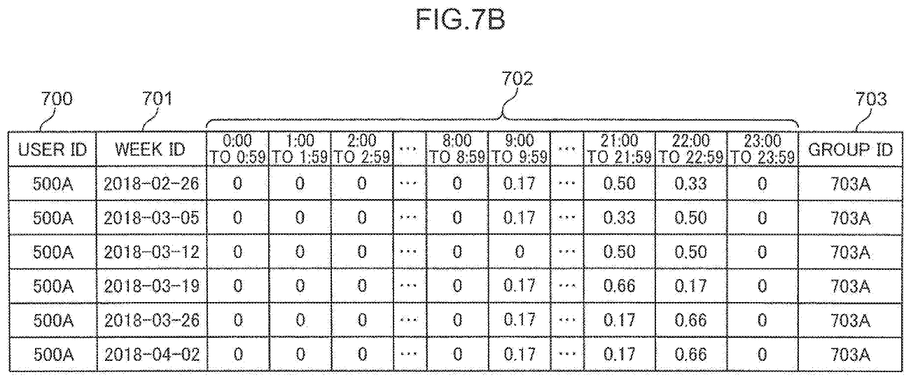

FIG. 7A is a view showing an example of operation distribution information in a case where a unit time period is set to one hour. As shown in FIG. 7A, operation distribution information includes items of a user ID 700, a week ID 701, and operation distribution 702. The user ID 700 is similar to the user ID 500 shown in FIGS. 4A and 4B, and the user ID 600 shown in FIGS. 6A and 6B. The week ID 701 is an ID for identifying a week, for which calculation of the operation distribution 702 in each unit time period is to be performed, regarding the domestic electrical appliance 100 which is possessed by a user identified by the user ID 700. Here, the week ID 701 is represented by a date of the first day of a week, for which calculation is to be performed. Each value in the operation distribution 702 indicates an operation occurrence rate of the domestic electrical appliance 100 in each unit time period of one day in a week identified by the week ID 701.

It is noted that one day is an example of a first duration, and one week is an example of a second duration. However, those are mere examples, and a value other than one day, such as two days, three days, or a half day, may be employed as the first duration. Also, any value that can be formed of a plurality of first durations, such as two days, three days, . . . six days, two weeks, or one month, other than one week, may be employed as the second duration.

Below, with reference to FIGS. 2B, 4B, 6B, and 7A, a process in which the operation-distribution-information generation unit 305 generates operation distribution information will be described. First, the operation-distribution-information generation unit 305 establishes correspondence between personal information (FIG. 4B) managed by the personal-information management unit 303 and appliance information (FIG. 6B) managed by the appliance-information management unit 304, using the user ID 500 and the user ID 600, and designates the appliance ID 605 of the domestic electrical appliance 100 possessed by each user. In an example in FIG. 6B, a user ID “500A” corresponds to a washing machine having an appliance ID “100A”, so that an appliance ID “100A” is designated as the appliance ID 605 of the domestic electrical appliance 100 possessed by a user having a user ID “500A”.

Subsequently, the operation-distribution-information generation unit 305 establishes correspondence between the appliance ID 605 which is designated for each user, and the appliance ID 400 included in operation log information (FIG. 2B) which is managed by the log-information management unit 302, and extracts the operating date-and-time 402 and the operating day 403 which indicate a time when a user's operation on the domestic electrical appliance 100 occurs, for each user. In the above-described example, regarding a user having a user ID “500A”, an appliance ID “100A” is designated, so that the operating date-and-time 402 and the operating day 403 which correspond to an appliance ID “100A” are designated based on operation log information shown in FIG. 2B. Additionally, in a case where a user having a user ID “500A” possesses a plurality of domestic electrical appliances 100, the operating date-and-time 402 and the operating day 403 which correspond to each of the plurality of domestic electrical appliances 100 are designated based on log information shown in FIG. 2B.

Subsequently, the operation-distribution-information generation unit 305 classifies the operating date-and-times 402 and the operating days 403 which are extracted for each user, according to week, counts the number of times of occurrence of an operation on the domestic electrical appliance 100 in each unit time period, and calculates an operation occurrence rate of the domestic electrical appliance 100 in each unit time period.

In an example in FIG. 2B, during a week from Monday, Feb. 26, 2018 to Sunday, Mar. 4, 2018, the domestic electrical appliance 100 having an appliance ID “100A” is operated once between 9:00 to 9:59, three times between 21:00 to 21:59, and twice between 22:00 and 22:59, i.e., six times in total. Here, an operation occurrence rate in each unit time period is defined by a ratio of the number of times of operation in each unit time period to the total number of times of operation on the domestic electrical appliance 100 for one week, as represented by the following expression.

An operation occurrence rate in a unit time period (i)=the number of times of operation in a unit time period (i)/the total number of times of operation for one week.

Thus, as shown in FIG. 7A, regarding a user who has a user ID “500A” and possesses the domestic electrical appliance 100 having an appliance ID “100A”, respective operation occurrence rates in unit time periods in the operation distribution 702 including a week ID “2018-02-26” are as follows.

That is, an operation occurrence rate between 9:00 and 9:59 is “⅙” or approximately “0.17”, an operation occurrence rate between 21:00 and 21:59 is “ 3/6” or “0.50”, an operation occurrence rate between 22:00 and 22:59 is “ 2/6” or approximately “0.33”, and an operation occurrence rate in each of the other unit time periods is “0”. It is noted that though a unit time period is equally set to one hour here, arbitrary time periods such as “morning”, “daytime”, “evening”, “night”, and “midnight” may be employed.

Reference is made back to FIG. 1. In the operation-distribution-information storage unit 306, operation distribution information which is generated by the operation-distribution-information generation unit 305 is cumulatively stored. FIG. 7B is a view showing an example of operation distribution information which is stored in the operation-distribution-information storage unit 306 in a case where a unit time period is set to one hour. As shown in FIG. 7B, operation distribution information stored in the operation-distribution-information storage unit 306 is managed in a table form in which one record corresponds to one piece of operation distribution information, and includes an item of a group ID 703, in addition to the items of the user ID 700, the week ID 701, and the operation distribution 702 which are included in operation distribution information shown in FIG. 7A. The group ID 703 is an ID of a group which indicates a user's mode of living obtained by classification of operation distribution information, and has a value which is updated by the change estimation unit 308 which will be later described. Immediately after operation distribution information generated by the operation-distribution-information generation unit 305 is added to the operation-distribution-information storage unit 306, a value of the group ID thereof is set to “NOT BELONG”.

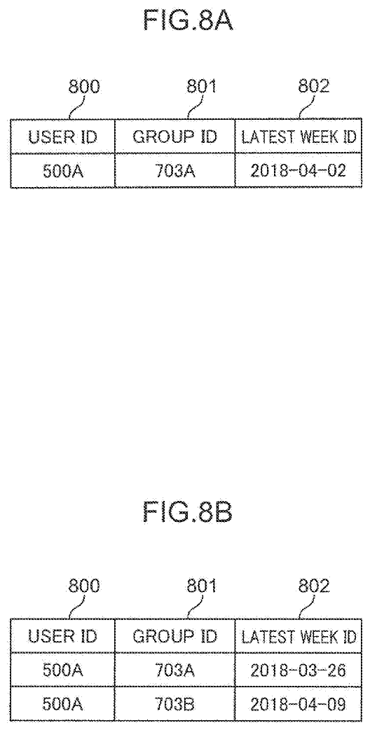

The group management unit 307 manages group information which is used by the change estimation unit 308 in estimating a change in a mode of living. FIG. 8A is a view showing an example of group information which is managed by the group management unit 307. As shown in FIG. 8A, group information managed by the group management unit 307 is managed in a table form in which one record corresponds to one piece of group information, and includes items of a user ID 800, a group ID 801, and a latest week ID 802. Among those items, the user ID 800 and the group ID 801 are similar to the user ID 700 and the group ID 703 shown in FIG. 7B, respectively.

The latest week ID 802 indicates a value of the week ID 701 which is represented by the latest date in pieces of operation distribution information belonging to a group. In the example in FIG. 7B, pieces of operation distribution information each including a group ID “703A” are shown, and a piece of information including a week ID “2018-04-02” is one that has the week ID 701 which is represented by the latest date. Accordingly, in an example in FIG. 8A, “2018-04-02” is set as a value of the latest week ID 802 for a group ID “703A”.

Reference is made back to FIG. 1. The change estimation unit 308 estimates whether or not a change is caused in a user's mode of living related to personal information, based on operation log information including an operating date-and-time of the domestic electrical appliance 100. Specifically, the change estimation unit 308 estimates whether or not a change is caused in a user's mode of living, based on operation distribution information (FIG. 7B) stored in the operation-distribution-information storage unit 306 and group information managed by the group management unit 307, and outputs an estimation result to the notification unit 309 which will be later described.

It is noted that a change in a mode of living includes a change in a family structure because of marriage, birth, bereavement, or the like, changes in a place and a state of residence due to a move, a change of an occupation, and the like.

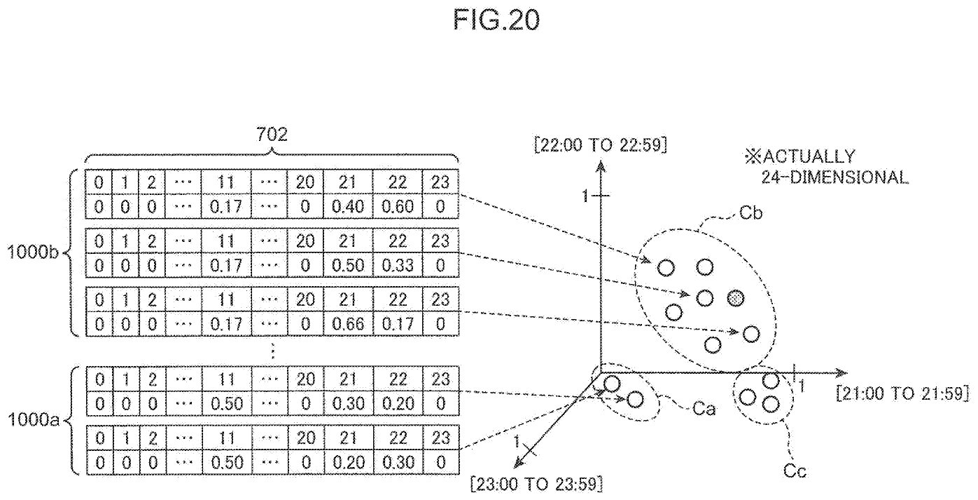

FIG. 20 is a view briefly explaining an estimating process performed by the change estimation unit 308. On a left-hand side of FIG. 20, five chronologically-consecutive pieces of operation distribution information which is generated by the operation-distribution-information generation unit 306 are shown. The change estimation unit 308 divides those pieces of operation distribution information into a first operation distribution party 1000a including two pieces of operation distribution information for most recent two weeks, and a second operation distribution party 1000b including pieces of operation distribution information other than those included in the first operation distribution party 1000a.

On a right-hand side of FIG. 20, a graph obtained by plotting of operation distribution information shown on a left-hand side of FIG. 20 in a space of coordinates is shown. Though a three-dimensional graph formed of three axes for a 21:00-to-21:59 time period, a 22:00-to-22:59 time period, and a 23:00-to-23:59 time period is shown for convenience in description in this example, this graph is actually a 24-dimensional graph formed of 24 axes for 24 time periods from 0:00 to 23:59 because the operation distribution 702 is formed of 24 unit time periods from 0:00 to 23:59, in operation distribution information.

In this example, in pieces of operation distribution information forming the second operation distribution party 1000b, the respective operation distributions 702 have the same tendency, so that those pieces belong to the same group Cb. In contrast thereto, in the two pieces of operation distribution information forming the first operation distribution party 1000a, the respective operation distributions 702 have tendencies different from that of the group Cb, and the respective operation distributions 702 have the same tendency, so that those pieces are grouped as a group Ca different from the group Cb. When such a tendency as described above appears in operation distribution information, the change estimation unit 308 estimates that a user's mode of living is changed. It is noted that a group Cc is a group which is obtained by grouping of operation distribution information which precedes operation distribution information forming the group Cb, for example.

Reference is made back to FIG. 1. When the change estimation unit 308 outputs an estimation result that a change is caused in a user's mode of living, the notification unit 309 sends an update request which requests a user to update personal information, to the information processing terminal 200 of a user via the communications unit 301, within a predetermined time frame from an instant of estimation. In this case, the notification unit 309 refers to the e-mail address 501 or the like included in personal information managed by the personal-information management unit 303 and specifies a destination address of the information processing terminal 200 possessed by a corresponding user, so that the notification unit 309 can send an update request to the specified destination address.

Additionally, regarding timing for sending an update request, an update request can be sent with appropriate timing. That is, an update request can be sent immediately after an instant when it is judged that a change is estimated to be caused in a mode of living, after a few hours, such as one hour or two hours, from the foregoing instant, after a half day from the foregoing instant, or on a day following a day in which the foregoing instant is included. Also, notification of an update request may be provided with another timing which will be described later in a second embodiment.

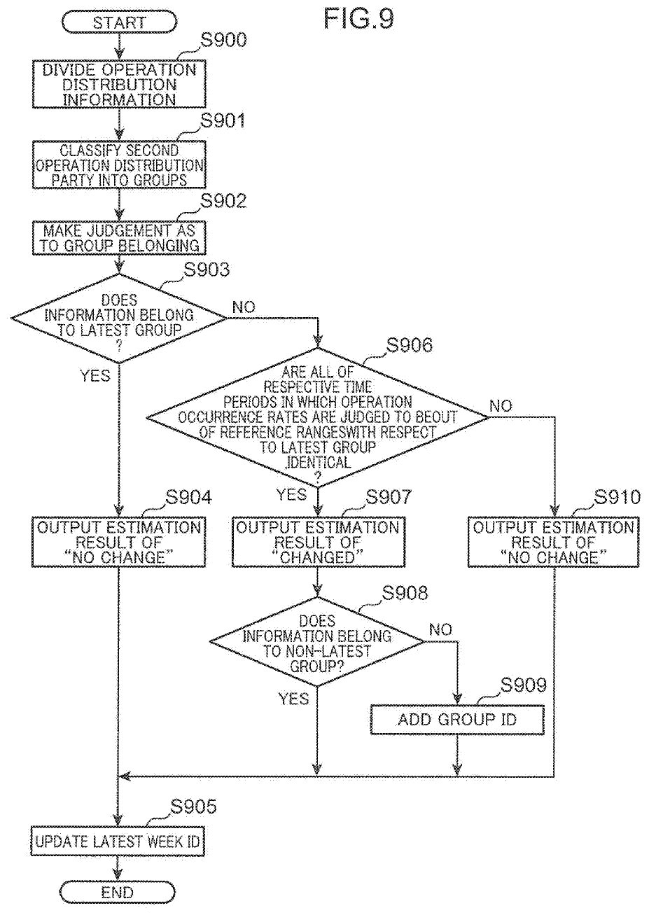

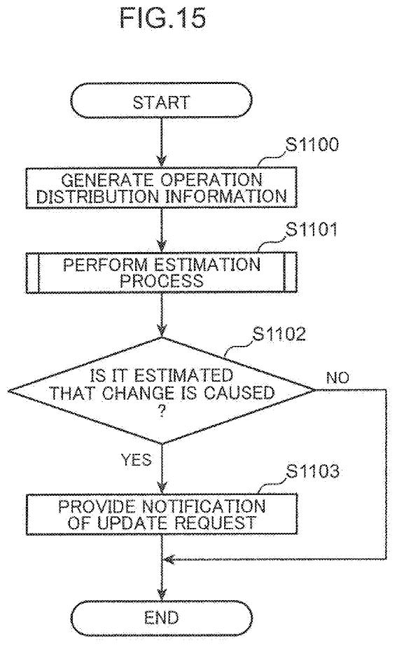

FIG. 9 is a flow chart showing an example of an estimation process performed by the change estimation unit 308 shown in FIG. 1. Below, with reference to FIG. 9, an estimation process in which the change estimation unit 308 estimates whether or not a change is caused in a user's mode of living will be described. It is noted here that the estimation process shown in FIG. 9 is performed as a subroutine of a step S1101 in a flow chart of FIG. 15 which will be later described. A process flow in FIG. 15 is performed once a week, for example, and thus also the estimation process in FIG. 9 is performed once a week. However, that is a mere example, and in a case where a duration other than one week is employed as a second duration, the process flows in FIGS. 9 and 15 may be performed in a cycle conforming to a length of the duration employed as a second duration.

(Step S900)

The change estimation unit 308 extracts all pieces of operation distribution information including the user ID 700 of a user who is related to personal information, a change of which is to be estimated, from the operation-distribution-information storage unit 306, and divides the extracted pieces of operation distribution information into the first operation distribution party and the second operation distribution party, with the use of a value of the week ID 701. The first operation distribution party includes pieces of operation distribution information for the most recent plural weeks. The second operation distribution party includes pieces of operation distribution information for plural weeks before the most recent plural weeks.

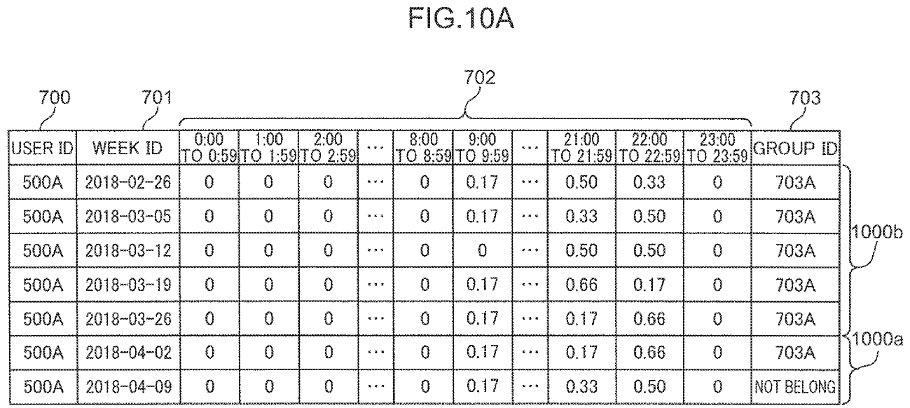

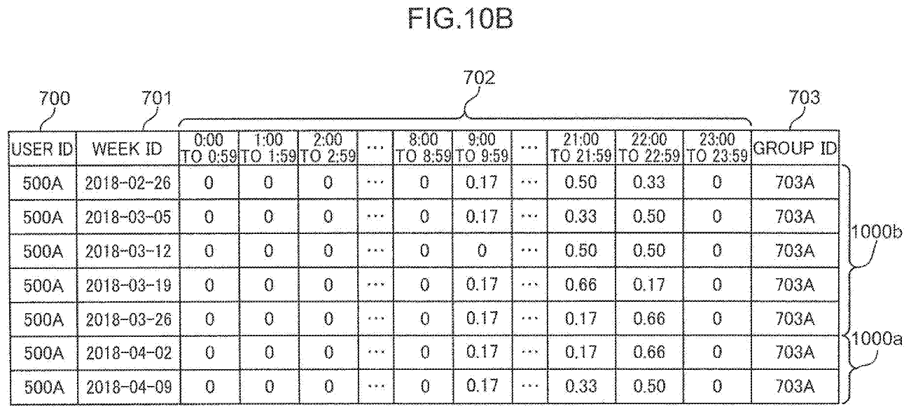

FIG. 10A is a view showing an example of operation distribution information which is provided immediately after operation distribution information including a week ID “2018-04-09” is stored in the operation-distribution-information storage unit 306. In this example, as a requirement for extraction of information for the first operation distribution party, employed is a requirement that information is related to the most recent two weeks. For this reason, by a process in the step S900, operation distribution information for the most recent two weeks, that is, two pieces of operation distribution information including a week ID “2018-04-02” and a week ID “2018-04-09” are extracted as the first operation distribution party 1000a, from operation distribution information in FIG. 10A. Also, operation distribution information for weeks before the most recent two weeks, that is, five pieces of operation distribution information including a week ID “2018-03-26” and its preceding week IDs, are extracted as the second operation distribution party 1000b, from operation distribution information in FIG. 10A.

It is noted that any plural number can be employed as the number of pieces of operation distribution information included in the first operation distribution party, and the number may be three or more, or four or more, for example, being not limited to two. As the number of pieces of operation distribution information included in the first operation distribution party increases, an accuracy in estimation of a change in a user's mode of living is correspondingly enhanced though a duration required for estimating that a change is caused in a user's mode of living is lengthened.

(Step S901)

The change estimation unit 308 classifies pieces of operation distribution information forming the second operation distribution party into one or more groups with the use of a value of the group ID 703. In the example in FIG. 10A, in each of all pieces of operation distribution information forming the second operation distribution party 1000b, a value of the group ID 703 is “703A”. Accordingly, in the example in FIG. 10A, each of all pieces of operation distribution information forming the second operation distribution party 1000b is judged to belong to a group having a group ID “703A”.

(Step S902)

The change estimation unit 308 judges to which group out of groups classified in the step S901, a piece of operation distribution information in which a value of the group ID 703 is “NOT BELONG” (this piece will be hereinafter referred to as a “target piece of operation distribution information) belongs, among pieces of operation distribution information forming the first operation distribution party.

Specifically, first, the change estimation unit 308 calculates an average μ and a standard deviation 6 of an operation occurrence rate in each unit time period for each of groups into which pieces of information in the second operation distribution party are classified in the step S901, and calculates a reference range for each unit time period from an average μ and a standard deviation σ. Here, as a reference range, a range of μ±2σ is employed, for example.

Next, the change estimation unit 308 judges to which group a target piece of operation distribution information belongs, depending on whether or not a value of an operation occurrence rate in each unit time period in a target piece of operation distribution information falls within a reference range for a corresponding unit time period of a target group. It is noted that a corresponding unit time period means that a unit time period of a target piece of operation distribution information is identical to a unit time period of a target group. That is, for a unit time period between 9:00 and 9:59 of a target piece of operation distribution information, a time period between 9:00 and 9:59 of a target group should be addressed, while for a unit time period between 10:00 and 10:59 of a target piece of operation distribution information, a time period between 10:00 and 10:59 of a target group should be addressed.

Assuming that respective operation occurrence rates in each unit time period in pieces of operation distribution information belonging to the same group follow a normal distribution, it can be considered that almost 95% of operation occurrence rates in each unit time period fall within a range of μ±2σ. Accordingly, it can be conceived that a target piece of operation distribution information in which a value of an operation occurrence rate in at least one unit time period is out of a reference range of a target group has an operation distribution having a tendency different from that of a target group by a factor which is unlikely to be caused by accident. Thus, if a value of an operation occurrence rate in at least one unit time period is out of a reference range of a target group, the change estimation unit 308 judges that a target piece of operation distribution information does not belong to a target group.

In the example in FIG. 10A, only a group having a group ID “703A” forms the second operation distribution party 1000b, and there are five pieces of operation distribution information in a group having a group ID “703A”. In this case, averages and standard deviations of respective operation occurrence rates in each unit time period in the operation distributions 702 in those five pieces of operation distribution information are calculated as follows.

Specifically, an average and a standard deviation between 9:00 and 9:59 are “0.136” and “0.068”, respectively, an average and a standard deviation between 21:00 and 21:59 are “0.432” and “0.167”, respectively, an average and a standard deviation between 22:00 and 22:59 are “0.432” and “0.167”, respectively, and both of an average and a standard deviation in each of the other unit time periods are “0”.

Accordingly, a reference range for each unit time period of a group having a group ID “703A” is calculated as follows. Specifically, a reference range between 9:00 and 9:59 is “0 to 0.272”, a reference range between 21:00 and 21:59 is “0.097 to 0.766”, a reference range between 22:00 and 22:59 is “0.097 to 0.766”, and a reference range for each of the other unit time periods is “0”. In the example in FIG. 10A, a currently-provided target piece of operation distribution information is a piece of operation distribution information which includes the group ID 703 having a value of “NOT BELONG” and includes a week ID “2018-04-09”, in the first operation distribution party 1000a. In this target piece of operation distribution information, an operation occurrence rate in each unit time period in the operation distribution 702 is as follows: an operation occurrence rate between 9:00 and 9:59 is “0.17”, an operation occurrence rate between 21:00 and 21:59 is “0.33”, an operation occurrence rate between 22:00 and 22:59 is “0.50”, and an operation occurrence rate in each of the other unit time periods is “0”. Consequently, in each unit time period, a value of an operation occurrence rate falls within a reference range for each unit period of a group having a group ID “703A”.

Therefore, a target piece of operation distribution information including a week ID “2018-04-09” is judged to belong to a group having a group ID “703A”.

After judgement as to belonging, when it is determined to which group a certain target piece of operation distribution information belongs, for a certain target piece, the change estimation unit 308 updates a value of the group ID 703 from “NOT BELONG” to a value of the group ID 703 of a group which is determined as the group to which the certain target piece belongs. FIG. 10B is a view showing operation distribution information which is provided immediately after a group to which each of pieces of operation distribution information shown in FIG. 10A belongs is determined. In the example in FIG. 10A, a piece of operation distribution information including the group ID 703 of “NOT BELONG” in the lowest row is judged to belong to a group having a group ID “703A”. Accordingly, in the example in FIG. 10B, a value of the group ID 703 of a piece of operation distribution information in the lowest row is updated to “703A” from “NOT BELONG”. It is noted that for operation distribution information which is judged as not belonging to any group as a result of judgement as to belonging, a value of the group ID 703 remains “NOT BELONG”.

(Step S903)

The change estimation unit 308 refers to the group ID 703 of operation distribution information in the first operation distribution party and group information managed by the group management unit 307, and judges whether all pieces of operation distribution information in the first operation distribution party belong to the same group which is already existing, and whether the group is the latest group. It is noted that the latest group means a group having the latest week ID 802, a value of which is the latest date among groups managed per user in group information.

In the example in FIG. 10B, all pieces of operation distribution information in the first operation distribution party 1000a belong to a group having a group ID “703A”. Further, by referring to group information in FIG. 8A, it is found that a group having a group ID “703A” is the only group related to a user having a user ID “500A”, and thus, the foregoing group is the latest group for a user having a user ID “500A”. Accordingly, in the example in FIG. 10B, it is judged that an answer is “YES” in the step S903.

To judge that an answer is “YES” in the step S903 indicates that in all pieces of operation distribution information forming the first operation distribution party, respective operation occurrence rates in each unit time periods have the same tendency as the latest group, so that it is estimated that no change is caused in a user's mode of living.

Additionally, as a case in which it is judged that an answer is “NO” in the step S903, cited are a case in which each of pieces of operation distribution information forming the first operation distribution party does not belong to the same group, a case in which each of pieces of operation distribution information forming the first operation distribution party belongs to the same group, but does not belong to the latest group, and the like.

The process goes to a step S904 if it is judged that an answer is “YES” in the step S903, and the process goes to a step S906 if it is judged that an answer is “NO” in the step S903.

(Step S904)

The change estimation unit 308 outputs an estimation result of “NO CHANGE” which indicates that no change is caused in a user's mode of living, to the notification unit 309.

(Step S905)

The change estimation unit 308 updates a value of the latest week ID 802 in group information managed by the group management unit 307 to a value of the week ID 701 of operation distribution information which is newly added to a group by a current estimation process, and finishes the estimation process.

In the example in FIG. 10B, a piece of operation distribution information including a week ID “2018-04-09” is newly added to a group having a group ID “703A”. In this case, in FIG. 8A, for a group having a group ID “703A”, a value of the latest week ID 802 is updated to “2018-04-09” from “2018-04-02”.

(Step S906)

The change estimation unit 308 judges whether all of respective unit time periods in each of which an operation occurrence rate is out of a reference range with respect to the latest group, in pieces of operation distribution information forming the first operation distribution party, are identical to each other. The process goes to a step S907 if the foregoing condition for judgement is satisfied (“YES” in the step S906), and the process goes to a step S910 if the foregoing condition for judgement is not satisfied (“NO” in the step S906).

To judge that an answer is “YES” in the step S906 indicates that respective operation occurrence rates in each unit time period in all pieces of operation distribution information forming the first operation distribution party have a tendency different from that of the latest group, but have the same tendency within the first operation distribution party. Specifically, it indicates that a change is caused in a unit time period in which a user operates the domestic electrical appliance 100, and the change continues. Accordingly, the change estimation unit 308 estimates that a change is caused in a user's mode of living, and proceeds to a step S907.

For example, consider a case in which the first operation distribution party 1000a includes first operation distribution information and second operation distribution information. Then, assume that regarding the first operation distribution information, operation occurrence rates in unit time periods between 9:00 and 9:59 and between 10:00 and 10:59 are judged to be out of respective reference ranges for unit time periods between 9:00 and 9:59 and between 10:00 and 10:59 of the latest group. Also, assume that regarding the second operation distribution information, operation occurrence rates in unit time periods between 9:00 and 9:59 and between 10:00 and 10:59 are out of respective reference ranges for unit time periods between 9:00 and 9:59 and between 10:00 and 10:59 of the latest group. In such a case, all of unit time periods in each of which an operation occurrence rate is judged to be out of a reference range with respect to the latest group in the first operation distribution unit, are identical to those in the second operation distribution unit, respectively, so that it is judged that an answer is “YES” in the step S906.

Additionally, as a case in which it is judged that an answer is “YES” in the step S906, cited is a case in which a user who used to wash using a washing machine at night increases the number of washing times due to childbirth, and makes it a custom to wash using a washing machine not only at night, but also in the morning, for example.

On the other hand, as a case in which it is judged that an answer is “NO” in the step S906, cited is a case in which though respective operation occurrence rates in each unit time period in a part of pieces of operation distribution information forming the first operation distribution party fall within reference ranges with respect to the latest group, an operation occurrence rate in at least one unit time period in the remaining pieces of operation distribution information is out of a reference range with respect to the latest group. Or, cited is a case in which respective unit time periods in each of which an operation occurrence rate is judged to be out of a reference range with respect to the latest group, in all of pieces of operation distribution information forming the first operation distribution party, are not identical to each other. Thus, either case indicates that though a change in a time period in which a user operates the domestic electrical appliance 100 is seen, the change does not continue. Therefore, in such cases, the change estimation unit 308 estimates that no change is caused in a user's mode of living, and proceeds to the step S910.

(Step S907)

The change estimation unit 308 outputs an estimation result of “CHANGED” which indicates that a change is caused in a user's mode of living, to the notification unit 309.

(Step S908)

The change estimation unit 308 judges whether all pieces of operation distribution information forming the first operation distribution party belong to a non-latest group. Here, it is noted that a non-latest group means a group other than the latest group, out of groups registered per user in group information. If respective values of the group IDs 703 in all pieces of operation distribution information forming the first operation distribution party are identical to each other and the value is other than “NOT BELONG”, the change estimation unit 308 judges that those pieces of operation distribution information belong to a non-latest group.

If it is judged that all pieces of operation distribution information forming the first operation distribution party belong to a non-latest group (“YES” in the step S908), the change estimation unit 308 dose not perform a process of a step S909, but proceeds to a step S905. On the other hand, if it is judged that all pieces of operation distribution information forming the first operation distribution party do not belong to a non-latest group (“NO” in the step S908), the change estimation unit 308 proceeds to a step S909.

To judge that an answer is “YES” in the step S908 indicates that in all pieces of operation distribution information forming the first operation distribution party, respective operation occurrence rates in each unit time periods have a tendency different from that of operation distribution information forming the latest group, but have the same tendency as that of operation distribution information forming any of non-latest groups. In other words, it means that a unit time period in which a user operates the domestic electrical appliance 100 is changed and a user's mode of living is returned to a former mode of living in which the user lived.

On the other hand, to judge that an answer is “NO” in the step S908 indicates that in all pieces of operation distribution information forming the first operation distribution party, respective operation occurrence rates in each unit time period have a tendency different from that of each of all pieces of former operation distribution information of a user, but have the same tendency within the first operation distribution party. That is, it means that a unit time period in which a user operates the domestic electrical appliance 100 is changed and an operation on the domestic electrical appliance 100 in a new unit time period which has never been seen, is repeated. Accordingly, in a case where respective operation occurrence rates in each unit time period in all pieces of operation distribution information forming the first operation distribution party have the same tendency and a value of the group ID 703 is “NOT BELONG”, it is judged that an answer is “NO” in the step S908.

(Step S909)

The change estimation unit 308 adds group information including a new group ID 801 to group information managed by the group management unit 307, and updates a piece of operation distribution information in which a value of the group ID 703 is “NOT BELONG”, out of pieces of operation distribution information stored in the operation-distribution-information storage unit 306, with the use of a value of the group ID 801 which is newly added (step S909).

FIG. 8B is a view showing an example in which group information including the new group ID 801 is newly added to group information which is managed by the group management unit 307. Here, a case in which group information which includes a group ID “703B” as the new group ID 801 is shown.

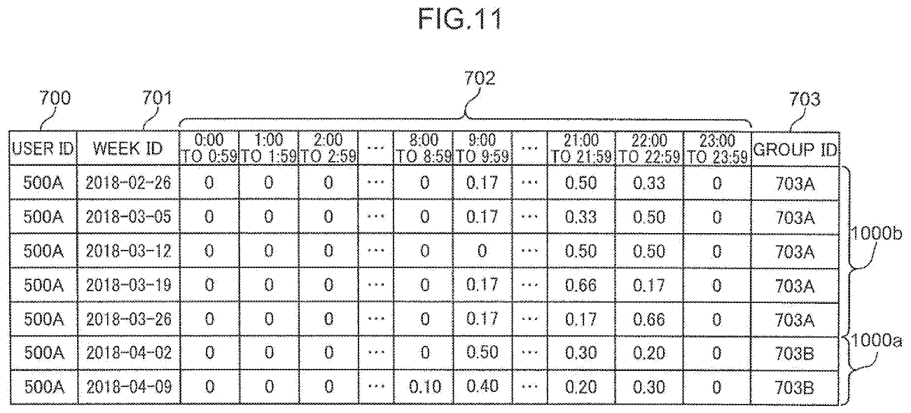

FIG. 11 is a view showing an example in which a new group ID is given to operation distribution information forming the first operation distribution party. In the example in FIG. 11, in pieces of operation distribution information including a week ID “2018-04-02” and a week ID “2018-04-09”, respectively, values of respective operation occurrence rates each in a time period between 9:00 and 9:59 are out of reference ranges of a group which is the latest group and has a group ID “703A”. Accordingly, in each of the pieces of operation distribution information, a value of the group ID 703 is updated to “703B”, a group ID which is newly added in FIG. 8B.

(Step S910)

The change estimation unit 308 outputs an estimation result of “NO CHANGE” which indicates that no change is caused in a mode of living, to the notification unit 309.

(Supplemental Remarks of Step S905)

It is noted that in the step S905 immediately after it is judged that an answer is “YES” in the step S908, a value of the latest week ID 802 of group information of a corresponding non-latest group is updated to a value of the week ID 701 of the latest piece of operation distribution information forming the first operation distribution party.

Also, in the step S905 immediately after the step S909, a value of the latest week ID 802 of a newly-added group is updated to a value of the week ID 701 of the latest piece of operation distribution information forming the first operation distribution party.

Also, in the step S905 immediately after the step S910, if a certain piece of operation distribution information belonging to a non-latest group is included in operation distribution information forming the first operation distribution party, a value of the latest week ID 802 of the corresponding non-latest group is updated to a value of the week ID 801 of the certain piece of operation distribution information.

Hereinabove, a specific procedure for the estimation process performed by the change estimation unit 308 has been described.

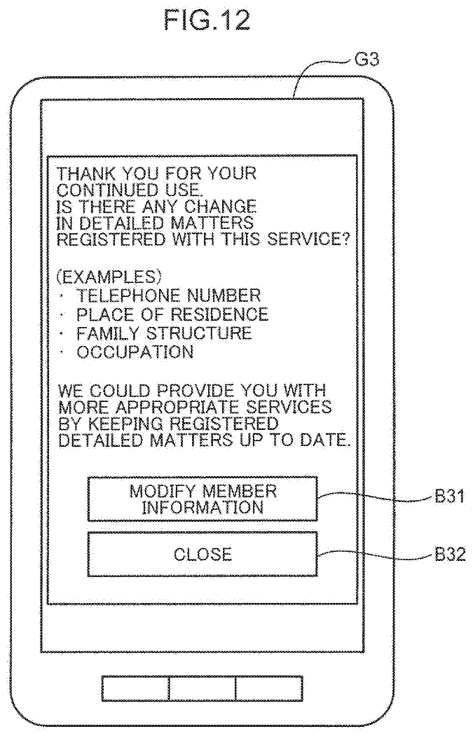

FIG. 12 is a view showing an example of a notification screen G3 displayed on the display unit 211 of the information processing terminal 200 which receives notification of an update request. The notification screen G3 is a screen which is displayed on the display unit 211 when it is estimated that a change is caused in a user's mode of living. At the beginning of the notification screen G3, a message which inquires whether or not a change is caused in personal information is displayed. Also, on a lower side of the message, examples of items of personal information regarding an inquiry are shown. Here, items of a telephone number, a place of residence (address), a family structure, and an occupation are shown as examples. On a lower side of the examples of items, merits of keeping registered detailed matters of personal information up to date are described. This makes it possible to cause a user to appreciate importance in updating personal information.

In a lower portion of the notification screen G3, a button B31 bearing “MODIFY MEMBER INFORMATION” and a button B32 bearing “CLOSE” are displayed.

When a user inputs an operation of selecting the button B31 using the input unit 212, the display control unit 204 shifts a screen being displayed on the display unit 211 to the registration screen G1 for personal information which is shown in FIG. 3. This allows a user to update his personal information to the latest information, on the registration screen G1. The button B32 is a button which is selected by a user in closing the notification screen G3. If there is no change in personal information, a user inputs an operation of selecting the button B32.

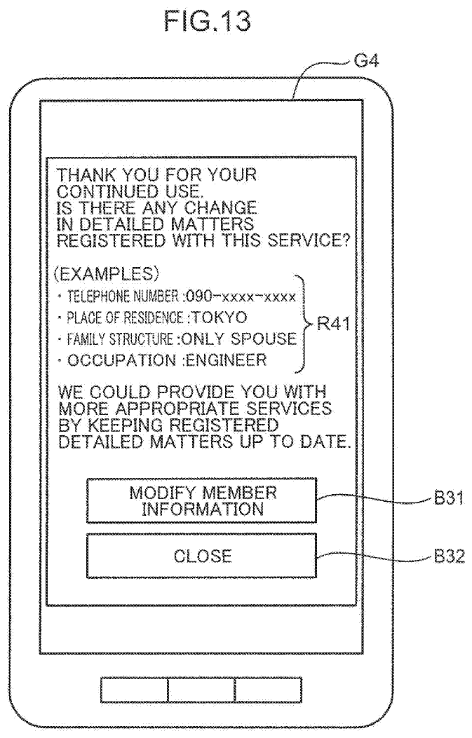

Additionally, the notification unit 309 of the server 300 may be designed so as to obtain registered detailed matters of current personal information of a corresponding user from the personal-information management unit 303 and notify a corresponding user of the registered detailed matters in such a manner that they are contained in an update request, in providing notification of an update request to the information processing terminal 200 possessed by a user. FIG. 13 is a view showing an example of a notification screen G4 which is displayed in a different manner on the display unit 211 of the information processing terminal 200 which receives notification of an update request. The notification screen G4 is different from the notification screen G3 in that detailed matters which are currently registered with a service provider, regarding items of a telephone number, a place of residence, a family structure, and an occupation, are displayed in a display section R41 of examples of items on a lower side of a message at the beginning. In the other respects, the notification screen G4 is identical to the notification screen G3.

As described above, detailed matters of personal information which is currently registered are displayed on the notification screen G4, so that a user can quickly recognize a difference between personal information which is being registered with a service provider and the latest personal information, and can easily judge whether or not it is necessary to update personal information.

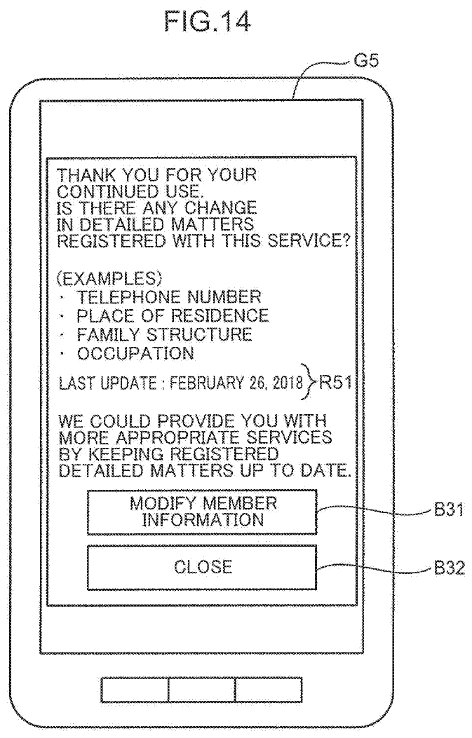

Also, the notification unit 309 may be designed so as to obtain a value of the last update date-and-time 510 from the personal-information management unit 303 and notify a user of the obtained value in such a manner that it is contained in an update request, in providing notification of an update request to the information processing terminal 200 possessed by a user. FIG. 14 is a view showing an example of another different notification screen G5 which is displayed on the display unit 211 of the information processing terminal 200 which receives notification of an update request. The notification screen G5 is different from the notification screen G3 in that a display section R51 in which the last date-and-time when a user updates personal information is displayed, is provided. In the other respects, the notification screen G5 is identical to the notification screen G3. Because of provision of the display section R51 in the notification screen G5, it is possible to show the last update date-and-time of personal information which is currently registered with a service provider, to a user, so that a user can easily judge whether or not it is necessary to update personal information.

Additionally, a combined configuration of the notification screen G4 and the notification screen G5 may be employed as a notification screen. In this case, currently-registered detailed matters displayed in the display section R41 of the notification screen G4, together with an update date of those registered detailed matters, are shown to a user.

Hereinabove, a functional configuration of the information updating system according to the first embodiment has been described. FIG. 15 is a flow chart showing an example of a process in which the server 300 of the information updating system shown in FIG. 1 estimates whether or not a change is caused in a user's mode of living, from operation log information about the domestic electrical appliance 100, and provides notification of an update request. It is noted that a process flow in FIG. 15 is performed for each user regularly, once a week, for example, as described above with reference to FIG. 9.

First, the operation-distribution-information generation unit 305 obtains a target user's operation log information which is stored in the log-information management unit 302 for one week until the current time, generates operation distribution information for the one week, and stores the generated information in the operation-distribution-information storage unit 306 (step S1100).

Subsequently, the change estimation unit 308 performs the estimation process shown in FIG. 9 in which it is estimated whether or not a change is caused in a target user's mode of living and an estimation result to the notification unit 309 is output (step S1101).

Subsequently, the notification unit 309, which receives an estimation result, judges whether or not an estimation result is “CHANGED” (step S1102). If an estimation result is “CHANGED” (“YES” in the step S1102), the process goes to a step S1103. If an estimation result is “NO CHANGE” (“NO” in the step S1102), the notification unit 309 does not notify a target user of an update request which requests an update of personal information, and finishes the process.

Subsequently, the notification unit 309 refers to the e-mail address 501 included in personal information which is managed by the personal-information management unit 303, and provides notification of an update request which requests an update of personal information such as a family structure or an occupation, to the information processing terminal 200 possessed by a target user (step S1103). Then, the process performed by the server 300 comes to an end.

As described above, the information updating system according to the first embodiment estimates whether or not a change is caused in a user's mode of living, regularly once a week, to thereby quickly keep track of a change in a user's mode of living and notify a user of an update request of personal information which is registered with a service provider. This makes it possible to prompt a user to update personal information concurrently with a duration in which a user himself conducts various procedures which are required due to a change in a mode of living. Accordingly, it is possible to increase a possibility of causing a user to update by himself, all pieces of personal information registered with a service provider, including personal information such as a family structure, an occupation, or the like of a user, a change of which is difficult for a service provider to keep track of. As a result of this, likeliness of a situation in which user's personal information which is registered with a service provider fails to be updated to the latest personal information, can be suppressed.

### Second Embodiment

According to a second embodiment, an at-home time period of a user is estimated from operation distribution information, and a user is notified of an update request within a predetermined time frame around an at-home time period.

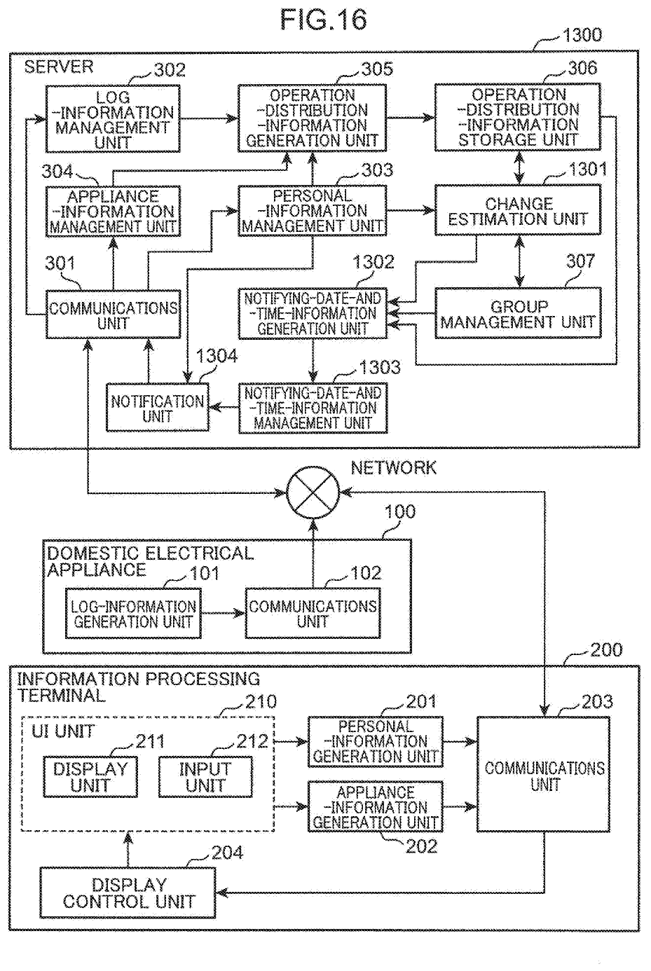

FIG. 16 is a view showing an example of an information updating system according to the second embodiment. Hereinafter, in the second embodiment, the same components as in the first embodiment will be denoted by the same reference signs and will not be described, and only differences from the first embodiment will be described.

In FIG. 16, differences from the first embodiment lie in a server 1300. The server 1300 further includes a notifying-date-and-time-information generation unit 1302 and a notifying-date-and-time-information management unit 1303, and a change estimation unit 1301 and a notification unit 1304 are different in function from the change estimation unit 308 and the notification unit 309 in the first embodiment, respectively.

The change estimation unit 1301, which performs the estimation process shown in FIG. 9 in the same manner as in the first embodiment, is different from that in the first embodiment in that a destination of output of an estimation result is not the notification unit 309, but the notifying-date-and-time-information generation unit 1302.

When the change estimation unit 1301 outputs an estimation result of “CHANGED” which indicates that a user's mode of living is changed, the notifying-date-and-time-information generation unit 1302 estimates an at-home time period in which a user is at home, from operation distribution information stored in an operation-distribution-information storage unit 306 and group information managed by a group management unit 307. Then, the notifying-date-and-time-information generation unit 1302 generates notifying-date-and-time information which indicates a date and a time at which notification of an update request of personal information should be provided to a user, and outputs the generated information to the notifying-date-and-time-information management unit 1303.

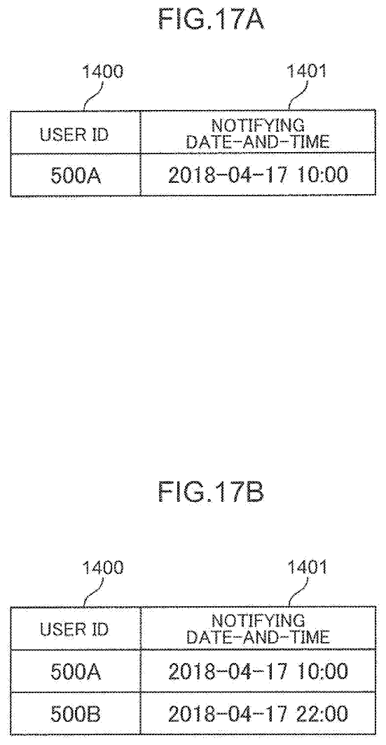

FIG. 17A is a view showing an example of notifying-date-and-time information generated by the notifying-date-and-time-information generation unit 1302. As shown in FIG. 17A, notifying-date-and-time information includes items of a user ID 1400 and a notifying date-and-time 1401. The user ID 1400 is similar to a user ID 700 included in operation distribution information. The notifying date-and-time 1401 is a date and a time at which an update request of personal information is actually sent to a user.

Below, with reference to group information in FIG. 8B and operation distribution information in FIG. 11 as specific examples, a process in which the notifying-date-and-time-information generation unit 1302 estimates an at-home time period of a user and generates notifying-date-and-time information, will be described.

When the notifying-date-and-time-information generation unit 1302 is notified of an estimation result of “CHANGED” by the change estimation unit 1301, the notifying-date-and-time-information generation unit 1302 obtains a value of a group ID 801 of a piece of group information in which a value of a latest week ID 802 is the latest, out of pieces of group information managed by the group management unit 307. In the example of group information in FIG. 8B, the latest one of values of the latest week IDs 802 is “2018-04-09”, and a value of the group ID 801 which has the foregoing latest value is “703B”. Accordingly, the notifying-date-and-time-information generation unit 1302 obtains a group ID “703B” from group information.

Subsequently, the notifying-date-and-time-information generation unit 1302 refers to the operation-distribution-information storage unit 306, and extracts all pieces of operation distribution information each including the earlier-obtained value of the group ID 801, as a value of the group ID 703, from operation distribution information in which the user ID 700 has a value assigned to a target user. In the above-described example, a group ID “703B” is earlier obtained, and operation distribution information in which a value of the group ID 703 is “703B” in FIG. 11 corresponds to two pieces of operation distribution information in which values of the week IDs 701 are “2018-04-02” and “2018-04-09”, respectively. Consequently, the notifying-date-and-time-information generation unit 1302 extracts those two pieces of operation distribution information from the operation-distribution-information storage unit 306.

Subsequently, the notifying-date-and-time-information generation unit 1302 calculates an average of occurrence operation rates in each unit time period in the extracted pieces of operation distribution information, and estimates that a unit time period in which the average is the largest is an at-home time period.

Subsequently, the notifying-date-and-time-information generation unit 1302 generates notifying-date-and-time information in which a value of the notifying date-and-time 1401 is set to be within a predetermined time frame around an at-home time period on a day next to a day when an estimation process for an at-home time period is performed. In the example in FIG. 11, in the earlier-extracted two pieces of operation distribution information in which values of the week IDs 701 are “2018-04-02” and “2018-04-09”, respectively, an average of operation occurrence rates in each unit time period is calculated as follows.

Specifically, an average between 8:00 and 8:59 is “0.05”, an average between 9:00 and 9:59 is “0.45”, an average between 21:00 and 21:59 is “0.25”, an average between 22:00 and 22:59 is “0.25”, and an average in each of the other unit time periods is “0”. Thus, a unit time period in which an operation occurrence rate is the highest in a day is between 9:00 and 9:59, so that this unit time period is estimated to be an at-home time period.

However, in a case where the domestic electrical appliance 100 is a washing machine, for example, a fact that the domestic electrical appliance 100 is operated means that a user does domestic chores in the estimated time period though being at home. Thus, when notification of an update request of personal information is provided in the estimated time period, a user probably does not cope with an update of personal information, doing domestic chores preferentially. Hence, the notifying-date-and-time-information generation unit 1302 sets a notifying date-and-time to a time period in which a user is very likely to be at home and an operation on the domestic electrical appliance 100 does not occur. In other words, the notifying-date-and-time-information generation unit 1302 sets a notifying time of an update request at 10:00, a little later time with respect to a 9:00-to-9:59 time period which is estimated to be an at-home period, as a time period in which domestic chores are not done.

In the example of group information in FIG. 8B, since the latest one of values of the latest week IDs 802 is “2018-04-09”, an estimation process for a change in a mode of living and an estimation process for an at-home time period are performed at “2018-04-16”.

The reasons for the above are as follows. That is, operation distribution information including a week ID “2018-04-09” is generated at “2018-04-16” at which storage of pieces of operation log information for one week from “2018-04-09” to “2018-04-15” is completed. Accordingly, an estimation process which is to be performed most recently after generation of operation distribution information including a week ID “2018-04-09” should be performed at “2018-04-16”.

Consequently, in this example, the notifying-date-and-time-information generation unit 1302 sets a sending date of an update request to “2018-04-17” next to a date of “2018-04-16” at which an estimation process is performed. Also, in this example, the notifying-date-and-time-information generation unit 1302 sets a notifying time of an update request at 10:00 as described above. Thus, in the example in FIG. 17A, notifying-date-and-time information in which a value of the notifying date-and-time 1401 is “2018-04-17 10:00” is generated.

Additionally, though in this example, a notifying time of an update request is set to “10:00” which is a time immediately after an estimated at-home time period between “9:00 and 9:59” ends, that is a mere example and a notifying time may be set to “8:59” which is a time immediately before an estimated at-home time period starts. Alternatively, a time (10:05, 10:10, or the like, for example) after a predetermined time interval from “10:00” which is a time immediately after an estimated at-home time period “between 9:00 and 9:59” ends, may be set as a notifying time, for example. Further alternatively, a notifying time may be set to a time (8:55, 8:50, and the like, for example) earlier by a predetermined time interval than “8:59” which is a time immediately before an estimated at-home time period between “9:00 and 9:59” starts, for example.

Reference is made back to FIG. 16. The notifying-date-and-time-information management unit 1303 stores notifying-date-and-time-information which is generated by the notifying-date-and-time-information generation unit 1302 into a memory, and manages notifying-date-and-time information. FIG. 17B is a view showing an example of notifying-date-and-time information which is managed by the notifying-date-and-time-information management unit 1303. As shown in FIG. 17B, notifying-date-and-time information is managed in a table form in which one record corresponds to one piece of notifying-date-and-time information, and includes items of the user ID 1400 and the notifying date-and-time 1401 in the same manner as in FIG. 17A.

The notification unit 1304 regularly refers to the notifying date-and-time 1401 in notifying-date-and-time information managed by the notifying-date-and-time-information management unit 1303, and judges whether or not there is notifying-date-and-time information in which the notifying date-and-time 1401 has the same value as a reference time. Then, if there is applicable notifying-date-and-time information, the notification unit 1304 refers to an e-mail address 501 or the like included in personal information managed by a personal-information management unit 303, using the user ID 1400 of the applicable notifying-date-and-time information, and provides notification of an update request to an information processing terminal 200 possessed by a user via a communications unit 301. Additionally, like the notification unit 309 in the first embodiment, the notification unit 1304 may contain currently-registered detailed matters of personal information and the last update date-and-time of personal information in an update request in providing notification of an update request.

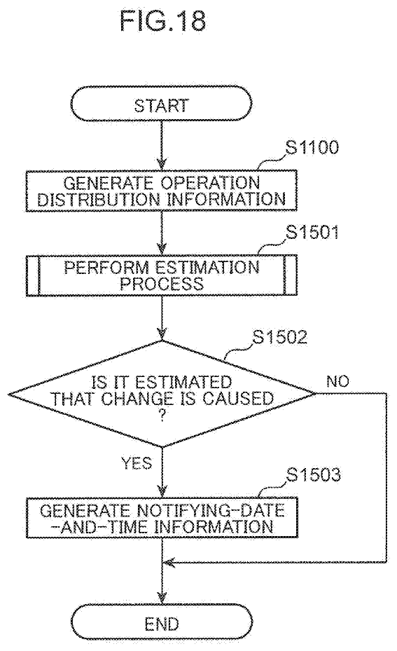

Hereinabove, a functional configuration of the information updating system according to the second embodiment has been described. FIG. 18 is a flow chart showing an example of a process in which the server 1300 of the information updating system according to the second embodiment estimates whether or not a change is caused in a user's mode of living, from operation-log information about a domestic electrical appliance 100, and then estimates an at-home time period of a user. This process flow is performed for each user regularly once a week in the server 1300 in the same manner as in the first embodiment. It is noted that in FIG. 18, the same steps as those in FIG. 9 are denoted by the same step numbers.

In a step S1501 following the step S1100, the change estimation unit 1301 performs an estimation process of estimating whether or not a change is caused in a mode of living of a target user and provides an estimation result to the notifying-date-and-time-information generation unit 1302. This estimation process is substantially the same as the estimation process in FIG. 9 in the first embodiment. Differences lie in that a destination to which an estimation result is sent in the step S904, the step S907, and the step S910 is not the notification unit 309, but the notifying-date-and-time-information generation unit 1302.

Subsequently, the notifying-date-and-time-information generation unit 1302 which receives an estimation result judges whether or not an estimation result is “CHANGED” (step S1502). If an estimation result is “CHANGED” (“YES” in the step S1502), the process goes to a step S1503. On the other hand, if an estimation result is “NO CHANGE” (“NO” in the step S1502), the notifying-date-and-time-information generation unit 1302 does not generate notifying-date-and-time information and finishes the process.

In the step S1503, the notifying-date-and-time-information generation unit 1302 estimates an at-home time period of a user from operation distribution information stored in the operation-distribution-information storage unit 306 and group information managed by the group management unit 307. Thereafter, the notifying-date-and-time-information generation unit 1302 determines a notifying data-and-time of an update request of personal information, generates notifying-date-and-time information which indicates the determined notifying-date-and-time, and outputs the generated information to the notifying-date-and-time-information management unit 1303. Then, the process comes to an end.

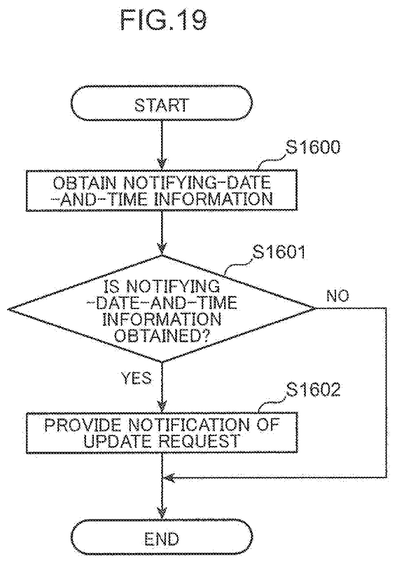

FIG. 19 is a flow chart showing an example of a process of notifying a user of an update request. A process flow in this chart is performed regularly every minute in the server 1300, for example. In this regard, an interval for performance of the process is set to one minute in order to achieve detection of notifying-date-and-time information in which a value of the notifying date-and-time 1401 has the same value as a reference time by causing the notification unit 1304 to refer to notifying-date-and-time information every minute.

The notification unit 1304 refers to notifying-date-and-time information managed by the notifying-date-and-time-information management unit 1303 and tries to obtain notifying-date-and-time information including the notifying date-and-time 1401 which has the same value as a current date-and-time (step S1600).

Subsequently, the notification unit 1304 judges whether or not applicable notifying-date-and-time information is obtained in the step S1600 (step S1601). If applicable notifying-date-and-time information is obtained (“YES” in the step S1601), the process goes to a step S1602. On the other hand, if applicable notifying-date-and-time information is not obtained (“NO” in the step S1601), the process comes to an end.

Subsequently, the notification unit 1304 refers to the e-mail address 501 or the like included in personal information managed by the personal-information management unit 303 based on the user ID 1400 included in notifying-date-and-time information obtained in the step S1600, and sends an update request to the information processing terminal 200 possessed by a target user (step S1602). Then, the process comes to an end.

Hereinabove, a specific procedure for the process in which the server 1300 of the information updating system according to the second embodiment estimates whether or not a change is caused in a user's mode of living, from operation log information about the domestic electrical appliance 100, further estimates an at-home time period of the user, and then notifies the user of an update request, has been described.

As described above, in the information updating system according to the second embodiment, notification of an update request can be provided at a specific date-and-time at which a user is estimated to be free, in a time period in which a user is very likely to be at home, so that a possibility of causing a user to cope with an update request can be increased.

(Modification)

(1) Though the operation-distribution-information generation unit 305 generates operation distribution information on a weekly basis in the first embodiment and the second embodiment, the present disclosure is not limited to that. For example, the operation-distribution-information generation unit 305 may be configured so as not to generate operation distribution information for a certain week in a case where a total of the number of times of occurrence of operation on the domestic electrical appliance 100 in the certain week is smaller than the predetermined number of times. As a result of this, operation distribution information for a week in which a custom of performing an operation on the domestic electrical appliance 100 is temporarily changed, such as an occasion on which a user stays away from home for several days because of a trip or homecoming, for example, is not taken into account in an estimation process for a change in a mode of living, so that reliability of estimation can be further enhanced. Here, as the predetermined number of times, a predetermined value by which a user can be considered to go out for a long term can be employed, for example. Also, the operation-distribution-information generation unit 305 may be configured not to generate operation distribution information for a certain week in a case where the number of times of operation remains equal to zero for two or more consecutive days in the certain week, for example.

(2) Though the notification unit 309 refers to notifying-date-and-time information every minute in the second embodiment, the present disclosure is not limited to that, and the notification unit 309 may refer to notifying-date-and-time information every five minutes on condition that as a value of the notifying date-and-time 1401, a value is set in five-minute increments such as “10:05” and “10:10” in notifying-date-and-time information, for example. Additionally, a five-minute interval is a mere example, and another appropriate time interval such as a four-minute interval or a six-minute interval may be set. Also, in a case where the notification unit 309 is designed so as to refer to notifying-date-and-time information every five minutes, notifying-date-and-time information in which a value of the notifying date-and-time 1401 is set at any time in five minutes before a reference time of notifying-date-and-time information, may be sent.

(3) For the process in the step S906 in FIG. 9, the following process may be employed as a process of judging that all of respective unit time periods in each of which an operation occurrence rate is judged to be out of a reference range with respect to the latest group, are identical. For example, assume that respective operation occurrence rates in unit time periods between 9:00 and 9:59 and between 10:00 and 10:59 in each of first operation distribution information and second operation distribution information which form the first operation distribution party 1000a are out of reference ranges with respect to the latest group. Then, further assume that in the first operation distribution information, an operation occurrence rate between 9:00 and 9:59 is higher than an upper limit of a reference range for a time period between 9:00 and 9:59 of the latest group, and an operation occurrence rate between 10:00 and 10:59 is lower than a lower limit of a reference range for a time period between 10:00 and 10:59 of the latest group. In such a case, if in the second operation distribution information, an operation occurrence rate between 9:00 and 9:59 is higher than an upper limit of a reference range for a time period between 9:00 and 9:59 of the latest group and an occurrence operation rate between 10:00 and 10:59 is lower than a lower limit of a reference range for a time period between 10:00 and 10:59 of the latest group, it may be judged that all of unit time periods in each of which an operation occurrence rate is judged to be out of a reference range with respect to the latest group in the first operation distribution information are identical to those in the second operation distribution information.

(4) Though a range of μ±2σ is employed as a reference range in the above-described embodiments, the present disclosure is not limited to that, and ranges of μ±1.5σ, μ±3σ, μ±σ, and the like, other than a range of μ±2σ, may be employed.

(5) In the above-described embodiments, when an operation occurrence rate in each of all unit time periods in a target piece of operation distribution information falls within a reference range of a target group, it is judged that the target piece of operation distribution information belongs to a target group. However, the present disclosure is not limited thereto. For example, when an operation occurrence rate in 70%, 80%, or 90% or higher of all unit time periods falls within a reference range for the same time period of a target group, it may be judged that a target piece of operation distribution information belongs to a target group.

### INDUSTRIAL APPLICABILITY

The present disclosure can increase a possibility of causing a user to update personal information at a time when a user's mode of living is very likely to be changed, so that useful techniques can be provided to companies which provide various services based on registered personal information.

This application is based on Japanese Patent application No. 2018-159579 filed in Japan Patent Office on Aug. 28, 2018, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An information updating method for updating user's personal information registered with a service provider that provides a service utilizing a domestic electrical appliance, the information updating method comprising:
estimating, by a computer, whether or not a change is caused in a user's mode of living related to the personal information, based on operation log information including an operating date-and-time of the domestic electrical appliance possessed by a user; and
sending, by the computer, an update request that requests an update of the personal information to an information processing terminal of the user within a predetermined time frame from an instant of estimation when it is estimated that the user's mode of living is changed.

2. The information updating method according to claim 1, wherein in estimating whether or not the mode of living is changed, operation distribution information that indicates an operation occurrence rate of the domestic electrical appliance in each of a plurality of unit time periods forming a first duration is generated for each of second durations each of which is longer than the first duration, based on the operating date-and-time included in the operation log information, and it is estimated whether or not the mode of living is changed based on the operation distribution information.

3. The information updating method according to claim 2, wherein
in sending the update request to the information processing terminal, an at-home time period of the user is estimated based on the operation distribution information, and
the update request is sent to the information processing terminal within a predetermined time frame before and after the at-home time period that is estimated.

4. The information updating method according to claim 3, wherein in estimating the at-home time period, one of the plurality of unit time periods in which the operation occurrence rate of the domestic electrical appliance is the highest is estimated to be the at-home time period of the user, based on the operation distribution information.

5. The information updating method according to claim 2, wherein in estimating whether or not the mode of living is changed, when a number of times of occurrence of operation on the domestic electrical appliance for a certain one of the second durations is smaller than a predetermined number of times, the operation distribution information for the certain one of the second durations is not generated.

6. The information updating method according to claim 2, wherein
in estimating whether or not the mode of living is changed,
the operation distribution information that is generated for each of the second durations is divided into a first operation distribution party including pieces of the operation distribution information for most recent plural ones of the second durations, and a second operation distribution party including pieces of the operation distribution information for another plural ones of the second durations before the most recent plural second durations,
one or more groups are generated by classification of the pieces of the operation distribution information forming the second operation distribution party, according to a tendency of the operation occurrence rate in each of the unit time periods, and
when each of the pieces of the operation distribution information for each of the second durations, the pieces being included in the first operation distribution party, does not belong to a latest group that is one of the groups that includes a piece of the operation distribution information for a latest one of the second durations and the respective operation occurrence rates in each of the unit time periods in the pieces being included in the first operation distribution party have a same tendency, it is estimated that the mode of living is changed.

7. The information updating method according to claim 6, wherein
in estimating whether or not the mode of living is changed,
a reference range for each of the unit time periods is calculated for each of the groups, from an average and a standard deviation of the operation occurrence rate in each of the unit time periods, and
when in first operation distribution information that is a piece of the operation distribution information for a certain one of the second durations, the piece being included in the first operation distribution party, the operation occurrence rate in at least one of the unit time periods is out of the reference range for the same unit time period of the latest group, it is judged that the first operation distribution information does not belong to the latest group.

8. The information updating method according to claim 6, wherein
in estimating whether or not the mode of living is changed,
in all pieces of the operation distribution information included in the first operation distribution party, when all of the respective unit time periods in each of which the operation occurrence rate is out of the reference range with respect to the latest group are identical to each other, it is judged that the respective operation occurrence rates in each of the unit time periods have a same tendency.

9. The information updating method according to claim 1, wherein the update request contains detailed matters of the personal information that is currently registered with the service provider.

10. The information updating method according to claim 1, wherein the update request contains information about a last update date-and-time of the personal information that is currently registered with the service provider.

11. The information updating method according to claim 1, wherein the change in the mode of living includes at least one of a change in a family structure and a change in an occupation.

12. The information updating method according to claim 2, wherein the first duration is one day.

13. The information updating method according to claim 2, wherein the second duration is one week.

14. An information updating system for updating user's personal information registered with a service provider that provides a service utilizing a domestic electrical appliance, the information updating system comprising:
a change estimation unit configured to estimate whether or not a change is caused in a user's mode of living related to the personal information, based on operation log information including an operating date-and-time of the domestic electrical appliance possessed by a user; and
a notification unit configured to send an update request that requests an update of the personal information to an information processing terminal of the user within a predetermined time frame from an instant of estimation when it is estimated that the user's mode of living is changed.

15. A computer-readable recording medium which stores an information updating program which causes a computer to execute the information updating method recited in claim 1.
